(19) United States
(12) Patent Application Publication
(10) Pub. No.: US 2026/0352890 A1
(43) Pub. Date: Nov. 5, 2026

(54) PROCESSING SUPPLEMENTAL ENHANCEMENT INFORMATION (SEI) MESSAGES FOR ADVANCED DRIVER ASSISTANCE SYSTEMS (ADAS)

(71) Applicant: QUALCOMM Incorporated, San Diego, CA (US)

(72) Inventors: Louis Joseph Kerofsky, San Diego, CA (US); Yong He, San Diego, CA (US); Shuai Zhao, Rancho Cordova, CA (US)

(21) Appl. No.: 19/649,886

(22) Filed: Apr. 16, 2026

Related U.S. Application Data
(60) Provisional application No. 63/797,397, filed on Apr. 30, 2025.

(51) Int. Cl. H04N 19/70; H04N 19/154; H04N 19/184; H04N 19/196; H04N 19/44

(52) U.S. Cl. CPC H04N 19/70; H04N 19/154; H04N 19/184; H04N 19/196; H04N 19/44

(57) ABSTRACT

A device for processing video data may be configured to process one or more supplemental enhancement information (SEI) messages including data describing the video data. For example, the video data may be of an area around a vehicle for use in training an artificial intelligence/machine learning (AI/ML) model for use in an advanced driving assistance system (ADAS) unit. The SEI messages may include data representing any or all of rolling shutter information for a camera used to capture the video data, optical distortion/correction model information represented using one of Woodscape or Brown-Conrady, and/or camera extrinsics information for the camera (e.g., a format in which rotation information is expressed, such as quaternions, 3×3 rotation matrices, or Euler angles).

This application claims the benefit of U.S. Provisional Application No. 63/797,397, filed Apr. 30, 2025, the entire contents of which are hereby incorporated by reference.

### TECHNICAL FIELD

This disclosure relates to computer vision systems, such as advanced driver and assistance (ADAS) systems.

### BACKGROUND

Techniques are being researched and developed related to advanced driving assistance systems. For example, artificial intelligence and machine learning (AI/ML) systems are being developed and trained to determine how best to operate a vehicle according to applicable traffic laws, safety guidelines, external objects, roads, and the like. Using cameras to collect images, depth estimation is performed to determine depths of objects in the images. Depth estimation can be performed by leveraging various principles, such as calibrated stereo imaging systems and multi-view imaging systems.

Various techniques have been used to perform depth estimation. For example, test-time refinement techniques include applying an entire training pipeline to test frames to update network parameters, which necessitates costly multiple forward and backward passes. Temporal convolutional neural networks rely on stacking of input frames in the channel dimension and bank on the ability of convolutional neural networks to effectively process input channels. Recurrent neural networks may process multiple frames during training, which is computationally demanding due to the need to extract features from multiple frames in a sequence and does not reason about geometry during inference. Techniques using an end-to-end cost volume to aggregate information during training are more efficient than test-time refinement and recurrent approaches, but are still non-trivial and difficult to map to hardware implementations.

### SUMMARY

In general, this disclosure describes techniques related to advanced driving assistance systems (ADAS). In particular, an ADAS unit may be configured to use an artificial intelligence/machine learning (AI/ML) model to determine objects in an area around a vehicle including the ADAS unit. The AI/ML model may be configured to determine the objects based on multi-modal inputs, such as multiple cameras to capture video data and point cloud input, e.g., determined using light detection and ranging (LIDAR), radio detection and ranging (RADAR), or the like. Training data to develop such an AI/ML model may need to include descriptive data for cameras used to capture the video data.

Per techniques of this disclosure, one or more supplemental enhancement information (SEI) messages may be used to convey such descriptive data. The descriptive data may include any or all of data representing rolling shutter information for a camera used to capture the video data, optical distortion/correction model information represented using one of Woodscape or Brown-Conrady, and/or camera extrinsics information for the camera (e.g., a format in which rotation information is expressed, such as quaternions, 3×3 rotation matrices, or Euler angles). In this manner, the training data may be used to more effectively generate the AI/ML model, thereby improving object detection capabilities of an ADAS unit, which may further improve driving assistance provided by the ADAS unit.

In one example, a method of processing video data includes: decoding video data of a bitstream to form decoded video data, the bitstream including the video data and a supplemental enhancement information (SEI) message including one or more camera parameters for a camera used to capture the video data; extracting the one or more camera parameters from the SEI message; determining physical capture characteristics of the camera used to capture the video data from the one or more camera parameters; and processing the decoded video data based on the physical capture characteristics to form processed video data.

In another example, a device for processing video data includes: a memory configured to store video data of a bitstream; and a processing system implemented in circuitry and configured to: decode the video data of the bitstream to form decoded video data, the bitstream including the video data and a supplemental enhancement information (SEI) message including one or more camera parameters for a camera used to capture the video data; extract the one or more camera parameters from the SEI message; determine physical capture characteristics of the camera used to capture the video data from the one or more camera parameters; and process the decoded video data based on the physical capture characteristics to form processed video data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle including an advanced driving assistance system (ADAS) unit according to techniques of this disclosure.

FIG. 2 is a block diagram illustrating an example set of components of an advanced driving assistance system (ADAS) unit according to techniques of this disclosure.

FIG. 3 is a block diagram illustrating an example set of components that may be included in a bird's eye view (BEV) determination unit according to techniques of this disclosure.

FIG. 4 is a block diagram illustrating an example vehicle with a multi-camera system and an advanced driving assistance system (ADAS) unit according to techniques of this disclosure.

FIG. 5 is a block diagram illustrating an example set of devices that may perform techniques of this disclosure.

FIG. 6 is a flowchart illustrating an example method of processing video data using a supplemental enhancement information (SEI) message per techniques of this disclosure.

### DETAILED DESCRIPTION

Advanced driving assistance systems (ADAS) use computer vision algorithms, such as depth estimation and three-dimensional object detection, configured to process multi-modal sensor data including video data. Training artificial intelligence and machine learning (AI/ML) models for ADAS requires accurate representation of physical capture characteristics of cameras used to capture the video data. Existing video coding standards provide supplemental enhancement information (SEI) messages to convey metadata. However, existing SEI messages do not adequately describe automotive imaging ecosystems. For instance, existing SEI messages lack parameters for rolling shutter cameras, omit common optical distortion models like Woodscape and Brown-Conrady used for fisheye lenses, and restrict camera orientation formats, thereby hindering accurate multi-sensor fusion and robust AI/ML model training.

Techniques of this disclosure provide enhancements to SEI messages to accurately signal physical capture characteristics of cameras. A device configured to process video data extracts camera parameters from an SEI message associated with a video bitstream. The camera parameters define physical capture characteristics, such as a rolling shutter scan interval, specific optical distortion models, and spatial poses of the camera in a three-dimensional space. The device processes decoded video data based on the determined physical capture characteristics.

Applying techniques of this disclosure may provide several advantages. Signaling rolling shutter parameters preserves capture artifacts in training data, improving performance of algorithms natively processing unrectified images. Specifying exact optical distortion models prevents loss of image content caused by naive rectification. Furthermore, providing flexible camera extrinsic information, such as unit quaternions and translation vectors, facilitates precise alignment of multiple sensors, such as cameras and light detection and ranging (LIDAR) units. Consequently, devices utilizing the disclosed SEI messages more accurately reconstruct three-dimensional scenes, enhance bi-focal stereo depth calculations, and improve overall accuracy of ADAS operations.

Depth estimation is an important component of advanced driving assistance systems (ADAS) or other systems used to assist a human driver with control of a vehicle or other device, e.g., for navigation. Depth estimation may also be used for extended reality (XR) related tasks, such as augmented reality (AR), mixed reality (MR), or virtual reality (VR). Depth information is important for accurate three-dimensional (3D) detection and scene representation. Depth estimation for such techniques may be used for driving assistance, augmented reality/virtual reality scene composition, image editing, or other such techniques. Other types of image processing can also be used for ADAS or other such systems, such as semantic segmentation, object detection, or the like. Vehicles configured for ADAS assistance may use various sensors such as light detection and ranging (LIDAR) units, RADAR units, and/or one or more cameras (e.g., monocular cameras, stereo cameras, or multi-camera arrays, which may face different directions).

Three-dimensional scene reconstruction is another important application that may benefit from accurate rolling shutter capture details. Modern approaches such as Neural Radiance Fields and classical structure-from-motion methods can achieve higher accuracy when trained on natively captured images that retain rolling shutter artifacts. Providing the exact physical capture characteristics of the rolling shutter cameras via the SEI messages may allow these algorithms to model the capture geometry properly, thereby improving the scene reconstruction process without requiring prior naive rectification of the training images.

Three-dimensional object detection (3DOD) may include generating a bird's eye view (BEV) representation of a three-dimensional space. That is, while cameras may capture images to the sides of a moving object, such as a vehicle, and a LIDAR unit may capture a point cloud representation, the camera and LIDAR data may be used to generate a bird's eye view perspective, i.e., a top-down perspective. Downstream tasks, such as object tracking and prediction, may benefit from a BEV representation. Creating an accurate BEV representation from multi-sensor data, such as cameras and LIDAR, is often important for perception-based tasks, such as object detection, tracking, and motion forecasting.

Video data may be captured and encoded for storage and later use in training artificial intelligence/machine learning (AI/ML) models that may be used for ADAS. Coding (encoding and decoding) of video data generally involves partitioning a picture of an image sequence into individual blocks, forming a prediction block for each block, and coding a residual block representing sample-by-sample differences between an original block and the prediction block. Prediction may be intra-frame (that is, within the frame including the current block being coded) or inter-frame (that is, from a different frame than the frame including the current block being coded).

Coded video data may be organized into network abstraction layer (NAL) units, which provide a “network-friendly” video representation addressing applications such as video telephony, storage, broadcast, or streaming. NAL units can be categorized as Video Coding Layer (VCL) NAL units and non-VCL NAL units. VCL units may contain data for the core compression engine and may include block and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and supplemental enhancement information (SEI) NAL units, among others. Parameter sets may contain sequence-level header information (in sequence parameter sets (SPS)) and infrequently changing picture-level header information (in picture parameter sets (PPS)). With parameter sets (e.g., PPS and SPS), infrequently changing information need not be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) messages may contain information that is not necessary for decoding coded pictures of VCL NAL units, but may assist in processes related to decoding, display, error resilience, and other purposes. SEI messages may be contained in non-VCL NAL units. SEI messages are the normative part of some standard specifications, and thus, are not always mandatory for a standards-compliant decoder implementation. SEI messages may be sequence level SEI messages or picture level SEI messages. Some sequence level information may be contained in SEI messages, such as scalability information SEI messages in the example of scalable video coding (SVC) and view scalability information SEI messages in multi-view video coding (MVC). These example SEI messages may convey information on, e.g., extraction of operation points and characteristics of the operation points.

A standard may specify video usability information (VUI) and SEI messages used within a video bitstream. Versatile Supplemental Enhancement Information (VSEI), per ITU-T H.274 and ISO/IEC 23002-7, is an example of such a standard. The SEI mechanism enables encoders to include metadata in the bitstream that is not required for the correct decoding of sample values of output pictures, but can be used for various other purposes. Encoders can include any number of SEI NAL units in an access unit, and each SEI NAL unit may contain one or more SEI messages. Specifications and systems using versatile video coding (VVC) may require encoders to generate certain SEI messages or may define specific handling of particular types of received SEI messages.

ADAS-equipped vehicles may have many cameras to capture multiple images from a variety of perspectives around the vehicle, which may be used to develop an understanding of the environment and execute ADAS driving tasks. An important aspect is the collection of training data. It is important that this training data accurately reflect the sensor data the vehicle will receive. As an example, fisheye cameras are frequently used to collect wide viewing angle images which are distorted. The distorted version should be used for training rather than rectifying the image to create a good-looking image by sacrificing some image content.

Standardized test data sets commonly used in automotive and computer vision applications rely on specific distortion and camera extrinsic models to preserve image content. For example, the Woodscape dataset, which provides extensive unrectified fisheye camera imagery for tasks such as semantic segmentation and depth estimation, describes optical distortion using a specific angle polynomial radial distortion model and specifies camera orientations using unit quaternions. Similarly, the nuScenes large-scale ADAS dataset models optical distortion based on the Brown-Conrady model, which includes both radial and tangential distortion parameters, and likewise uses quaternions for rotations. Because existing SEI messages do not support these exact models natively, augmenting SEI messages to directly signal Woodscape or Brown-Conrady distortion parameters and unit quaternions allows models to be trained on these and similar raw datasets without loss of critical peripheral data or numerical instability during coordinate transformation.

Several SEI messages have been previously developed that describe some aspects of the automotive imaging ecosystem. The Shutter Interval Info (SII) SEI message provides some detail on the image capture process but does not provide detail on rolling shutter cameras, which are commonly used in consumer and automotive applications. In consumer applications, rolling shutter artifacts are typically removed prior to encoding the video to create pleasant looking pictures. In automotive applications, fast moving cameras exaggerate the impact of rolling shutter aspects and the need to preserve the character of the captured images in the training set is important.

The Lens Optical Correction (LOC) SEI message defines some models for lens distortion but does not include several of the distortion models commonly in use in the automotive domain and in the OpenCV tool.

The Sphere Rotation (SR) SEI message provides information on rotation angles yaw (α), pitch (β), and roll (γ) that are used for conversion between global coordinate axes and local coordinate axes. These angles are expressed in one format for describing a rotation, but this format can be awkward to use when combining rotations. As such, they are little used in automotive applications where the orientation relative to a fixed car is then combined with the rotation of a vehicle to get conversion to a world coordinate system.

The fisheye video information SEI message describes a polynomial for radial distortion mapping radial distance to angle, while Kannala-Brandt or Woodscape models are polynomials of the reverse, expressing the radial distance as a polynomial in the angle. The range of coefficients limit, i.e., [−128,128], does not include the values of typical Woodscape radial distortion polynomials. The Woodscape distortion model also does not have a focal length value needed by the fisheye distortion SEI message as well as many other syntax elements.

The Multiview Acquisition Information (MAI) SEI message describes extrinsic rotations only through a 3×3 rotation matrix with no ability to signal quaternions. Additionally, a specific coordinate system cannot be indicated.

Even when combined, these existing SEI messages do not address the needs of automotive applications. For example, existing SEI messages do not adequately convey information concerning details of rolling shutter capture, which may impact various algorithms and multi-sensor, e.g., LIDAR/camera time alignment. Existing SEI messages also do not adequately convey information concerning common optical distortion models (e.g., distortion related to fisheye lenses). Likewise, existing SEI messages do not adequately convey information concerning rotation via quaternions, despite being fundamental to many applications.

Per techniques of this disclosure, a video encoder and a video decoder may be configured to process (e.g., encode, form, decode, parse, and use) SEI messages including data pertinent to ADAS. For example, per techniques of this disclosure, a video encoder and a video decoder may be configured to process SEI messages including any or all of the data described above.

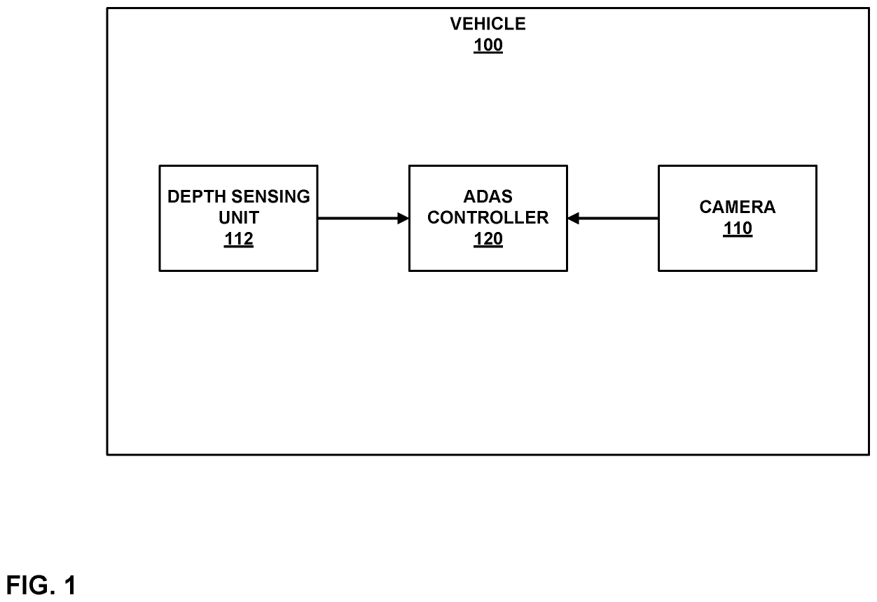

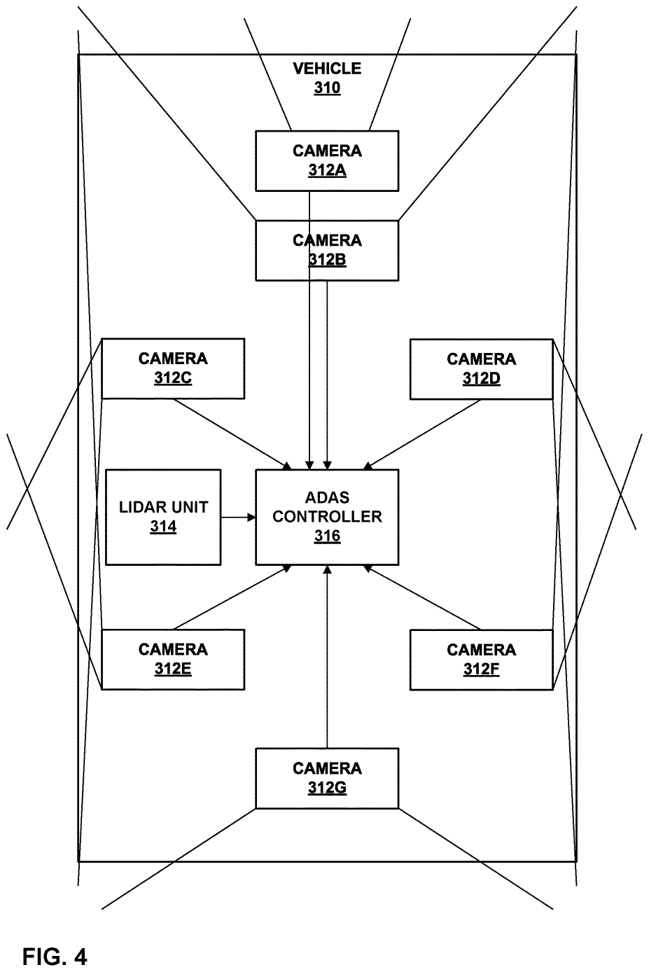

FIG. 1 is a block diagram illustrating an example vehicle 100 including an advanced driving assistance system (ADAS) controller 120 according to techniques of this disclosure. In this example, vehicle 100 includes camera 110, depth sensing unit 112, and ADAS controller 120. Camera 110 is a single camera in this example. While only a single camera is shown in the example of FIG. 1, in other examples, multiple cameras may be used. However, the techniques of this disclosure allow for depth to be calculated for objects in images captured by camera 110 without additional cameras. In some examples, multiple cameras may be employed that face different directions, e.g., front, back, and to each side of vehicle 100, e.g., as shown in FIG. 4. ADAS controller 120 may be configured to calculate depth for objects captured by each of such cameras.

Camera 110 captures video data representing a real-world environment. A video encoder encodes the video data into a bitstream. The bitstream includes the video data and one or more supplemental enhancement information (SEI) messages. The one or more SEI messages may include one or more camera parameters for camera 110 capturing the video data. The one or more camera parameters may indicate physical capture characteristics of camera 110. The physical capture characteristics may include a scan interval of a rolling shutter of camera 110. The one or more SEI messages may include a shutter interval information SEI message including a rolling shutter information extension including the scan interval of the rolling shutter of camera 110. The one or more camera parameters may include a syntax element specifying a rolling shutter scan order representing one of a top-to-bottom scan order, a bottom-to-top scan order, a left-to-right scan order, or a right-to-left scan order. The one or more camera parameters may include syntax elements representing a scan interval and a scan delay for each of a plurality of temporal sublayers in a coded layer video sequence (CLVS) of the video data.

The physical capture characteristics may include an optical distortion of a lens of camera 110. The optical distortion may represent a radial distortion model comprising at least one of an angle polynomial model or a Brown-Conrady model. In some examples, the radial distortion model represents the Brown-Conrady model. The one or more camera parameters may include at least one tangential distortion parameter.

The one or more camera parameters may include separate horizontal and vertical focal lengths and a horizontal and vertical focal center. The physical capture characteristics may include a spatial pose of camera 110 in a three-dimensional (3D) space. The one or more camera parameters may include a coordinate system indicator specifying one of a vehicle-centric coordinate system or a camera-centric coordinate system. The spatial pose may include a camera orientation indicated by one of unit quaternions, a rotation matrix, or Euler angles. The one or more camera parameters may include a three-component translation vector representing a translation relative to an origin of a world coordinate system.

Depth sensing unit 112 may include any or all of a light detection and ranging (LIDAR) unit, a radio detection and ranging (RADAR) unit, a depth from stereo unit, and/or other devices that calculate depth values for objects in a real-world environment. Depth sensing unit 112 provides point cloud data (e.g., LIDAR data) for vehicle 100 to ADAS controller 120. Depth sensing unit 112 may, for example, determine a point cloud for a three-dimensional area, where camera 110 also captures an image of the area. In the case of LIDAR, for example, the point cloud may generally include points corresponding to surfaces or objects in the area identified by a light (e.g., laser) emitted by depth sensing unit 112 and reflected back to depth sensing unit 112. Based on the angle of emission of the light from depth sensing unit 112 and time taken for the light to traverse from depth sensing unit 112 to the object and back, depth sensing unit 112 can determine a three-dimensional coordinate for the point.

ADAS controller 120 receives image frames captured by camera 110, e.g., at a high frame rate, such as 30 fps, 60 fps, 90 fps, 120 fps, or even higher. ADAS controller 120 also receives point cloud data captured by depth sensing unit 112, e.g., at a corresponding rate, such that a point cloud is paired with the image frame (or frames of a multi-camera system). ADAS controller 120 may include an (artificial) neural network trained according to the techniques of this disclosure to generate a depth map using fused features extracted from the frame(s) and the point cloud.

According to the techniques of this disclosure, ADAS controller 120 may receive a point cloud or other such data structure from depth sensing unit 112 and image data from camera 110 (at a given time). ADAS controller 120 may extract features from the point cloud (which may also be considered a type of range data) and camera image data, form respective projections using the extracted features, and fuse the projections to form a BEV representation.

By configuring ADAS controller 120 to process video data based on the physical capture characteristics signaled in the SEI messages, vehicle 100 may achieve various technical advantages. For example, processing rolling shutter scan intervals and delays for camera 110 may improve multi-sensor fusion. Because capture timing varies within a picture for rolling shutter cameras, accurate scan interval data may allow ADAS controller 120 to correctly identify correspondences between point cloud data from depth sensing unit 112 and video data from camera 110 with minimal temporal separation. Furthermore, providing specific optical distortion models, such as Woodscape or Brown-Conrady models, may prevent loss of image content associated with naive image rectification. Preserving such distorted image content may improve object detection accuracy in low-speed maneuvering scenarios, such as parking, by providing full-coverage near-field sensing without sacrificing pixel data.

Using camera extrinsic information, such as unit quaternions and translation vectors, may provide precise spatial poses for camera 110 relative to vehicle 100. Such precise spatial poses may enable ADAS controller 120 to more accurately map image features to a three-dimensional world coordinate system, thereby enhancing generation of bird's eye view representations. Additionally, preserving exact camera parameters within the video bitstream may provide highly representative training data for artificial intelligence and machine learning (AI/ML) models. By training AI/ML models on unrectified, natively captured images augmented with accurate timing and distortion metadata, resulting models may exhibit increased accuracy and robustness when deployed in real-world advanced driving assistance systems.

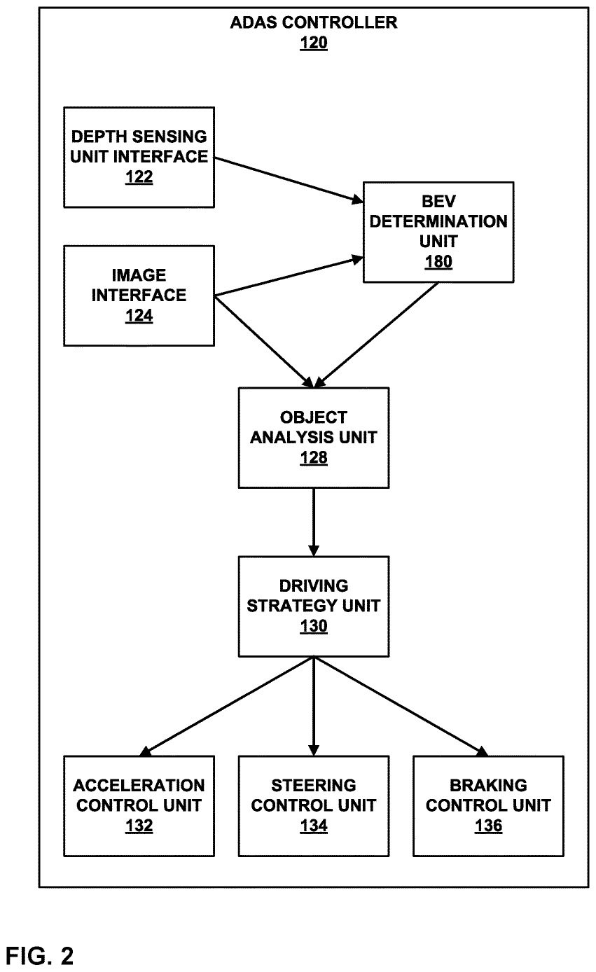

FIG. 2 is a block diagram illustrating an example set of components of ADAS controller 120 of FIG. 1 according to techniques of this disclosure. In this example, ADAS controller 120 includes depth sensing unit interface 122, image interface 124, bird's eye view (BEV) determination unit 180, object analysis unit 128, driving strategy unit 130, acceleration control unit 132, steering control unit 134, and braking control unit 136.

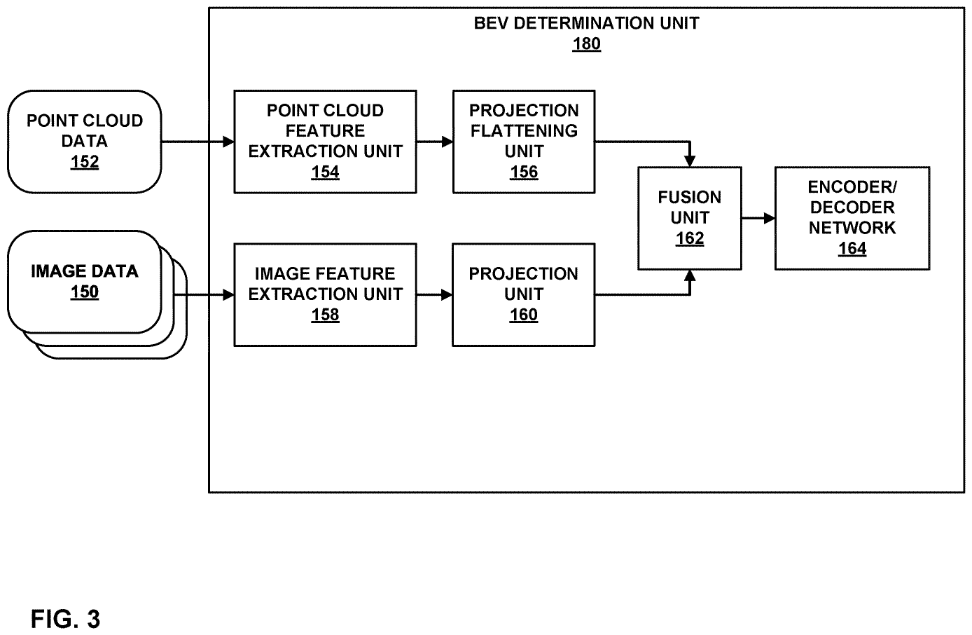

In general, depth sensing unit interface 122 represents an interface to depth sensing unit 112 of FIG. 1, which receives point cloud data (e.g., LIDAR data) from depth sensing unit 112 and provides the LIDAR/point cloud data to BEV determination unit 180. In particular, as described in greater detail below with respect to FIG. 3, BEV determination unit 180 may determine a BEV representation from images received via image interface 124 and a point cloud received via depth sensing unit interface 122. Per the techniques of this disclosure, BEV determination unit 180 may extract features from the images and the point cloud, form projection representations using the features, then merge the projections to form a fused initial BEV representation.

Image interface 124 may also provide the image frames to object analysis unit 128. Likewise, BEV determination unit 180 may provide depth values for objects in the images to object analysis unit 128. Object analysis unit 128 may generally determine where objects are relative to the position of vehicle 100 at a given time, and may also determine whether the objects are stationary or moving. Object analysis unit 128 may provide object data to driving strategy unit 130, which may determine a driving strategy based on the object data. For example, driving strategy unit 130 may determine whether to accelerate, brake, and/or turn vehicle 100. Driving strategy unit 130 may execute the determined strategy by delivering vehicle control signals to various driving systems (acceleration, braking, and/or steering) via acceleration control unit 132, steering control unit 134, and braking control unit 136.

Image interface 124 may receive decoded video data and physical capture characteristics. A video processing device may decode video data of a bitstream to form the decoded video data. The bitstream may include the video data and a supplemental enhancement information (SEI) message including one or more camera parameters for a camera used to capture the video data. The video processing device may extract the one or more camera parameters from the SEI message and determine the physical capture characteristics of the camera from the one or more camera parameters. The video processing device may provide the decoded video data and the physical capture characteristics to ADAS controller 120. BEV determination unit 180 and object analysis unit 128 may process the decoded video data based on the physical capture characteristics to form processed video data. The physical capture characteristics may include a scan interval of a rolling shutter of the camera, an optical distortion of a lens of the camera, and/or a spatial pose of the camera in a three-dimensional space. The optical distortion may represent a Woodscape optical distortion model or a Brown-Conrady optical distortion model. The spatial pose may include a camera orientation indicated by unit quaternions, a rotation matrix, or Euler angles.

The various components of ADAS controller 120 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

FIG. 3 is a block diagram illustrating an example set of components that may be included in BEV determination unit 180 of FIG. 2. In this example, BEV determination unit 180 includes point cloud feature extraction unit 154 that receives point cloud data 152, projection flattening unit 156, image feature extraction unit 158 that receives image data 150, projection unit 160, fusion unit 162, and encoder/decoder network 164. Multi-modal inputs, such as image and point cloud/LIDAR inputs, may help to make more accurate predictions of depth maps, reduce reliance on a single sensor, and also address common issues such as sensor occlusion, e.g., if an object is obstructing one or more cameras and/or the LIDAR unit at a given time. To process the multi-modal inputs, a processing system executing BEV determination unit 180 may process decoded video data based on physical capture characteristics extracted from one or more supplemental enhancement information (SEI) messages. Processing the decoded video data based on the physical capture characteristics may represent an example of generating processed video data.

In this example, BEV determination unit 180 receives one or more images in the form of image data (e.g., from one or more cameras, such as cameras in front, to the sides of, and/or to the rear of vehicle 100 of FIG. 1), and point cloud data 152. Point cloud feature extraction unit 154 extracts 3D sparse features from the point cloud data, such as occupancy information or local geometric descriptors. Point cloud feature extraction unit 154 provides the 3D sparse features to projection flattening unit 156. Similarly, image feature extraction unit 158 extracts perspective view features from the one or more images and provides the perspective view features to projection unit 160. Projection flattening unit 156 forms a flattened projection from the 3D sparse features (into BEV space), and projection unit 160 converts the image features from a perspective view to BEV projection.

The flattened projection and the BEV projection share a BEV space, in which fusion unit 162 can perform fusion for better spatial representation. Thus, fusion unit 162 receives the projections and fuses the projections to form an initial BEV representation.

Fusion unit 162 provides the initial BEV representation to encoder/decoder network 164. Encoder/decoder network 164 includes both an encoder and a decoder. The encoder of encoder/decoder network 164 processes the input features (camera features, LIDAR features, and/or the fusion of the camera features and the LIDAR features) and extracts higher-level feature maps. These feature maps may contain spatial and semantic information. The encoder can include several convolutional layers, which progressively downsample the input BEV feature map while capturing increasingly abstract spatial information (e.g., in the form of geometric primitives, such as polygons). The decoder of encoder/decoder network 164 may follow an upsampling process, where the encoded feature map is gradually restored to the original resolution of the BEV space.

By using point cloud feature extraction unit 154, image feature extraction unit 158, and fusion unit 162 to process multi-modal inputs in conjunction with physical capture characteristics, BEV determination unit 180 may improve multi-sensor fusion. For instance, incorporating rolling shutter scan intervals and delays into feature processing may allow fusion unit 162 to correctly temporally align image features with point cloud features, thereby minimizing temporal separation errors during feature fusion. Such precise temporal alignment may increase accuracy of initial bird's eye view representations generated by fusion unit 162.

Additionally, processing decoded video data based on Woodscape or Brown-Conrady optical distortion models may allow projection unit 160 to accurately project image features into a bird's eye view space without requiring naive image rectification that discards image content. Furthermore, using camera extrinsic information, such as unit quaternions and translation vectors, may provide numerically stable, exact camera spatial poses relative to a vehicle. By employing precise spatial poses and preserving exact image content, projection flattening unit 156 and projection unit 160 may more accurately transform extracted features into the shared bird's eye view space. Consequently, encoder/decoder network 164 may generate depth maps and object predictions with greater precision, thereby improving overall perception capabilities of advanced driving assistance systems.

FIG. 4 is a block diagram illustrating an example vehicle 310 with a multi-camera system and advanced driving assistance system (ADAS) controller 316 according to techniques of this disclosure. In particular, vehicle 310 includes cameras 312A-312G, and LIDAR unit 314. In this example, cameras 312A and 312B are front-facing cameras with different focal lengths, cameras 312C and 312D are side-rear facing cameras, cameras 312E and 312F are side-front facing cameras, and camera 312G is a rear-facing camera. In this manner, imagery can be captured by the collection/set of cameras 312A-312G for a 360 degree view around vehicle 310.

A video encoder encodes the images captured by cameras 312A-312G as video data of a bitstream. The bitstream includes the video data and supplemental enhancement information (SEI) messages including camera parameters for cameras 312A-312G. A video decoder decodes the video data of the bitstream to form decoded video data. ADAS controller 316 extracts the camera parameters from the SEI messages and determines physical capture characteristics of cameras 312A-312G from the camera parameters. ADAS controller 316 processes the decoded video data based on the physical capture characteristics.

LIDAR unit 314 may generate LIDAR/point cloud data around vehicle 310 in 360 degrees. Thus, LIDAR/point cloud data may be generated for images captured by each of cameras 312A-312G. Both images and LIDAR data may be provided to ADAS controller 316.

ADAS controller 316 may include components similar to those of ADAS controller 120 of FIG. 2. For example, ADAS controller 316 may include a BEV determination unit that performs the techniques of this disclosure, as discussed above, to extract features from the images and LIDAR data, fuse the extracted features, then generate a depth map from the fused features. In particular, ADAS controller 316 may track features extracted from images and LIDAR data over time, e.g., from consecutive frames, according to the techniques of this disclosure, to generate a BEV representation of a real-world space around vehicle 310. ADAS controller 316 may then use the BEV representation when making driving assistance decisions to at least partially control vehicle 310.

By configuring ADAS controller 316 to process video data from cameras 312A-312G and point cloud data from LIDAR unit 314 using camera parameters extracted from SEI messages, vehicle 310 may achieve enhanced 360-degree environmental perception. For example, by using rolling shutter scan intervals and scan delays extracted from the SEI messages, ADAS controller 316 may precisely align specific point cloud sweeps from LIDAR unit 314 with corresponding individual pixels captured by cameras 312A-312G. Minimizing temporal separation between multi-modal sensor inputs may reduce alignment errors during multi-sensor fusion. Furthermore, for front-facing cameras 312A and 312B operating as a bifocal stereo pair with differing focal lengths, applying exact rolling shutter timing parameters prevents depth calculation failures caused by mismatched pixel capture times, thereby improving stereo depth estimation accuracy.

In a specific multi-sensor fusion example, LIDAR unit 314 may be a rotating LIDAR scanner operating at a frequency of 10 Hz while cameras 312A-312G may capture video data at a frequency of 25 Hz. To accurately fuse these modalities, ADAS controller 316 may identify the temporally nearest LIDAR frame for each pixel of the camera images. With a global shutter camera, the temporally nearest LIDAR frame may be independent of the image row and depends only on the column, as all pixels in a row are captured simultaneously. However, with a rolling shutter camera, the temporally nearest LIDAR frame for a given pixel may depend on both the column and the row of the pixel due to the scan delay. ADAS controller 316 may use the rolling shutter scan interval and scan delay parameters extracted from the SEI messages to correctly identify the exact correspondence between the LIDAR samples and the camera pixels with minimal temporal separation.

Additionally, employing wide-angle or fisheye lenses for cameras 312A-312G may reduce a total number of sensors required to achieve full 360-degree coverage around vehicle 310. By processing decoded video data based on specific optical distortion models, such as Woodscape or Brown-Conrady models, ADAS controller 316 may evaluate highly distorted edge regions of captured images without requiring naive rectification. Preserving raw distorted pixel values avoids discarding critical peripheral image content. Moreover, extracting camera extrinsic information, such as unit quaternions, may provide numerically stable, exact spatial poses for each respective camera of cameras 312A-312G. By fusing unrectified wide-angle image features mapped via precise spatial poses, ADAS controller 316 may generate highly accurate bird's eye view representations for robust execution of automated driving tasks.

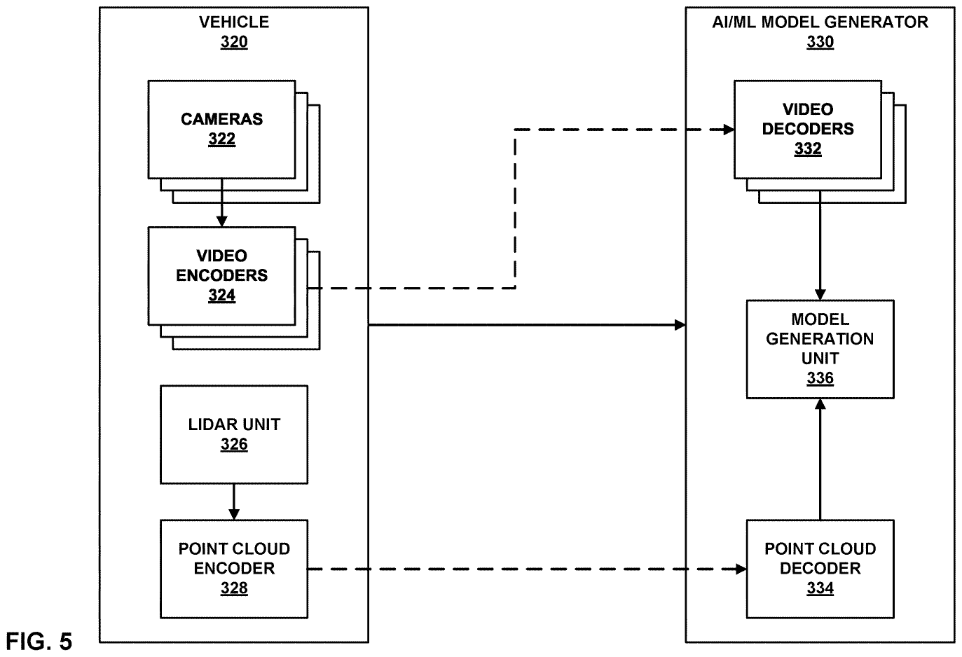

FIG. 5 is a block diagram illustrating an example set of devices that may perform techniques of this disclosure. The example of FIG. 5 depicts vehicle 320 and AI/ML model generator 330. In this example, vehicle 320 includes cameras 322, video encoders 324, LIDAR unit 326, and point cloud encoder 328. While LIDAR unit 326 is used as an example, other point cloud generation units, such as a RADAR unit, may be used in addition or in the alternative. In the example of FIG. 5, AI/ML model generator 330 includes video decoders 332, point cloud decoder 334, and model generation unit 336.

In general, cameras 322 may capture video data from a variety of perspectives, e.g., as shown in FIG. 4. Video encoders 324 may encode video data captured by cameras 322, e.g., according to ITU-T H.264/Advanced Video Coding, ITU-T H.265/High Efficiency Video Coding, ITU-T H.266/Versatile Video Coding, AOMedia Video 1 (AV1), or the like. LIDAR unit 326 may simultaneously collect point cloud data and provide such point cloud data to point cloud encoder 328. Vehicle 320 may provide both encoded video data and encoded point cloud data to AI/ML model generator 330.

In particular, vehicle 320 may be configured to output a bitstream, and AI/ML model generator 330 may be configured to receive a bitstream, via a computer-readable medium. The computer-readable medium may represent any type of medium or device capable of transporting the bitstream from vehicle 320 to AI/ML model generator 330. In one example, the computer-readable medium represents a communication medium to enable vehicle 320 to transmit encoded video data, encoded point cloud data, and non-VCL NAL units (e.g., SEI messages) directly to AI/ML model generator 330 in real-time, e.g., via a radio frequency network or computer-based network. Vehicle 320 may modulate a transmission signal including the encoded video data, and AI/ML model generator 330 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from vehicle 320 to AI/ML model generator 330.

AI/ML model generator 330 may receive a bitstream including encoded video data, encoded point cloud data, and any or all of the various SEI messages of this disclosure and/or other such SEI messages. Video decoders 332 may decode video data from video encoders 324, and point cloud decoder 334 may decode point cloud data from point cloud encoder 328. Video decoders 332 may provide decoded video data to model generation unit 336, while point cloud decoder 334 may provide decoded point cloud data to model generation unit 336. Ultimately, model generation unit 336 may generate an AI/ML model to be used for object detection and recognition in conjunction with ADAS processing. Such model may be provided to, e.g., ADAS controller 120 for detection of objects and for BEV generation, which may be used to assist in ADAS tasks.

Alternatively, AI/ML model generator 330 may operate as a client device that receives the encoded video data and the SEI messages. Upon decoding the video data and parsing the SEI messages, the client device may pass the decoded video data and the extracted camera characteristics to a dedicated post-processing unit. The post-processing unit may then fix up or rectify the data based on the specific camera extrinsics, rolling shutter parameters, and optical distortion models provided in the SEI messages, thereby ensuring the data is accurately aligned and corrected before being consumed by downstream applications.

Video encoders 324, point cloud encoder 328, video decoders 332, point cloud decoder 334, and model generation unit 336 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoders 324, point cloud encoder 328, video decoder 332, and point cloud decoder 334 may be included in one or more encoders or decoders, either of which may be integrated as part of a combined encoder/decoder (CODEC) in a respective device. A device including video encoders 324, point cloud encoder 328, video decoders 332, and/or point cloud decoder 334, may implement video encoders 324, point cloud encoder 328, video decoders 332, and/or point cloud decoder 334 in processing circuitry such as an integrated circuit and/or a microprocessor. Such a device may be a wireless communication device, such as a cellular telephone, or any other type of device described herein.

By extracting and utilizing physical capture characteristics from the received SEI messages, AI/ML model generator 330 may generate more robust and accurate AI/ML models for advanced driving assistance systems. For instance, processing video data in conjunction with rolling shutter scan intervals and delays may allow model generation unit 336 to train AI/ML models using images that retain native rolling shutter artifacts. Retaining such native artifacts ensures the training data accurately reflects real-world high-speed camera motion, thereby improving performance of the generated AI/ML models during actual deployment. Furthermore, interpreting specific optical distortion models, such as Woodscape or Brown-Conrady models, may avoid naive image rectification and prevent loss of peripheral image data. Preserving distorted edge content provides superior training data for full-coverage near-field sensing and may improve object detection for low-speed maneuvering scenarios.

Moreover, applying camera extrinsic information extracted from the SEI messages, such as unit quaternions and translation vectors, provides precise spatial poses for cameras 322. Utilizing unit quaternions ensures numerical stability when calculating a cascade of rotations and enables precise alignment between multiple sensors. By fusing multi-modal training data using exact spatial poses and accurate temporal alignment, model generation unit 336 may generate AI/ML models capable of highly accurate three-dimensional scene reconstruction and bird's eye view generation. Consequently, deploying AI/ML models trained with exact physical capture characteristics may significantly enhance overall reliability and safety of ADAS driving tasks.

Video encoders 324 and video decoders 332 may be configured to code (encode or decode) supplemental enhancement information (SEI) messages as part of a video bitstream. Per techniques of this disclosure, such SEI messages may include new or revised SEI messages. For example, video encoders 324 and video decoders 332 may process a lens optical correction (LOC) SEI message including additional optical distortion models for the Woodscape and the Brown-Conrady model used in OpenCV. Additionally or alternatively, video encoders 324 and video decoders 332 may be configured to process a shutter interval info (SII) SEI message that has been extended by a Rolling Shutter Information SEI message, or alternatively, video encoders 324 and video decoders 332 may process a Rolling Shutter Information SEI message instead of an SII SEI message. Additionally or alternatively, video encoders 324 and video decoders 332 may be configured to process a camera extrinsic information SEI message, which may support three different orientation formats: quaternions, 3×3 rotation matrix, or Euler angles. The camera extrinsic information SEI message may include data representing a relevant coordinate system. Compared to the rotation matrix specification of MAI, non-rotation matrices are not supported and hence the range of parameters signaled for coefficient exponent can be reduced, for instance.

In some examples, video encoders 324 and video decoders 332 may process a rolling shutter information SEI message, which may modify or replace the SII SEI message. An example syntax structure for the rolling shutter information SEI message is shown below:

| | Descriptor |
|---|---|
| rolling_shutter_info(payloadSize ) { | |
| rsi_time_scale | u(32) |
| rsi_rolling_shutter_scan_order | u(2) |
| rsi_fixed_rolling_shutter_scan_within_clvs_flag | u(1) |
| if (rsi_fixed_rolling_shutter_scan_within_clvs_flag) { | |
| rsi_num_units_in_rolling_shutter_scan_interval | u(32) |
| rsi_num_units_in_rolling_shutter_scan_delay | u(32) |
| } | |
| else { | |
| rsi_max_sub_layers_minus1 | u(3) |
| for( i = 0; i <= rsi_max_sub_layers_minus1; i++ ) { | |
| rsi_sub_layer_num_units_in_rolling_shutter_scan_interval[ i ] | u(32) |
| rsi_sub_layer_num_units_in_rolling_shutter_scan_delay[ i ] | u(32) |
| } | |
| } | |
| } | |

The rolling shutter information SEI message may indicate a scan interval for associated video source pictures prior to encoding. For example, for camera-captured content, the scan interval may be the amount of time between scanning the first and the last pixel of a frame.

When a rolling shutter information SEI message is present for any picture of a coded layer video sequence (CLVS) of a particular layer, a rolling shutter information SEI message may be present for the first picture of the CLVS. The rolling shutter information SEI message may persist for the current layer in decoding order from the current picture until the end of the CLVS. Rolling shutter information SEI messages that apply to the same CLVS may have the same content.

Semantics for the rolling shutter information SEI message syntax elements may be as follows:
rsi_time_scale specifies the number of time units that pass in one second. The value of rsi_time_scale shall not be equal to 0. For example, a time coordinate system that measures time using a 27 MHz clock has an rsi_time_scale of 27 000 000.
rsi_rolling_shutter_scan_order indicates the rolling shutter scan order as specified in table X.

TABLE X

| rsi_rolling_shutter_scan_order | Scan order |
|---|---|
| 0 | Rolling shutter scans down pixels |
| | row by row from top to the bottom |
| | of the sensor |
| 1 | Rolling shutter scans up pixels |
| | row by row from bottom to the top |
| | of the sensor |
| 2 | Rolling shutter scans pixels |
| | column by column from left to the |
| | right of the sensor |
| 3 | Rolling shutter scans pixels |
| | column by column from right to |
| | the left of the sensor |

rsi_fixed_rolling_shutter_scan_within_clvs_flag equal to 1 specifies that the indicated rolling shutter scan, interval, and delay are the same for all temporal sublayers in the CLVS. rsi_fixed_rolling_shutter_scan_within_clvs_flag equal to 0 specifies that the indicated rolling shutter scan, interval, and delay may not be the same for all temporal sublayers in the CLVS.
rsi_num_units_in_rolling_shutter_scan_interval, when rsi_fixed_rolling_shutter_scan_within_clvs_flag is equal to 1, specifies the number of time units of a clock operating at the frequency rsi_time_scale Hz that corresponds to the indicated rolling shutter scan interval from first pixel to last pixel of each picture in the CLVS. The value 0 may be used to indicate that the associated video content contains screen capture content, computer generated content, or other non-camera-captured content.

The indicated rolling shutter scan interval, denoted by the variable rollingShutterScanInterval, in units of seconds, is equal to the quotient of rsi_num_units_in_rolling_shutter_scan_interval divided by rsi_time_scale. For example, to represent a rolling shutter scan interval equal to 0.04 seconds, rsi_time_scale may be equal to 27 000 000 and rsi_num_units_in_rolling_shutter_scan_interval may be equal to 1 080 000.
rsi_num_units_in_rolling_shutter_scan_delay, when rsi_fixed_rolling_shutter_scan_within_clvs_flag is equal to 1, specifies the number of time units of a clock operating at the frequency rsi_time_scale Hz that corresponds to the indicated rolling shutter scan delay of the first pixel of each picture in the CLVS.

The indicated rolling shutter scan delay, denoted by the variable rollingShutterScanDelay, in units of seconds, is equal to the quotient of rsi_num_units_in_rolling_shutter_scan_delay divided by rsi_time_scale. For example, to represent a rolling shutter scan delay equal to 0.004 seconds, rsi_time_scale may be equal to 27 000 000 and rsi_num_units_in_rolling_shutter_scan_delay may be equal to 108 000.
rsi_max_sub_layers_minus1 plus 1 specifies the maximum number of temporal sublayers that may be present in the CLVS. NOTE—For example, the information conveyed in this SEI message is intended to be adequate for purposes corresponding to the use of ATSC A/341:2022-03 Annex D when srsi_max_sub_layers_minus1 is equal to 1 and rsi_fixed_rolling_shutter_scan_within_clvs_flag is equal to 0.
rsi_sub_layer_num_units_in_rolling_shutter_scan_interval[i], when present, specifies the number of time units of a clock operating at the frequency rsi_time_scale Hz that corresponds to the rolling shutter scan interval of each picture with temporal sublayer identifier equal to i in the CLVS. The rolling shutter scan interval for each picture with temporal sublayer identifier equal to i in the CLVS, denoted by the variable subLayerRollingShutterScanInterval[i], in units of seconds, is equal to the quotient of rsi_sub_layer_num_units_in_rolling_shutter_scan_interval[i] divided by rsi_time_scale.
rsi_sub_layer_num_units_in_rolling_shutter_scan_delay[i], when present, specifies the number of time units of a clock operating at the frequency rsi_time_scale Hz that corresponds to the rolling shutter scan delay of each picture with temporal sublayer identifier equal to i in the CLVS. The rolling shutter scan delay for each picture with temporal sublayer identifier equal to i in the CLVS, denoted by the variable subLayerRollingShutterScanDelay[i], in units of seconds, is equal to the quotient of rsi_sub_layer_num_units_in_rolling_shutter_scan_delay[i] divided by rsi_time_scale.

The variables subLayerRollingShutterScanInterval[i] and subLayerRollingShutterScanDelay[i], corresponding to the indicated rolling shutter scan interval from first pixel to last pixel of each picture and rolling shutter scan delay of the first pixel of a frame with temporal sublayer identifier equal to i in the CLVS, is thus derived as follows:

```
if(rsi_fixed_rolling_shutter_scan_within_clvs_flag) {
  subLayerRollingShutterScanInterval[ i ] =
rsi_num_units_in_rolling_shutter_scan_interval ÷ rsi_time_scale
  subLayerRollingShutterScanDelay[ i ] =
rsi_num_units_in_rolling_shutter_scan_delay ÷ rsi_time_scale
}
else{
  subLayerRollingShutterScanInterval[ i ] =
rsi_sub_layer_num_units_in_rolling_shutter_scan_interval[ i ] ÷
rsi_time_scale
  subLayerRollingShutterScanDelay[ i ] =
rsi_sub_layer_num_units_in_rolling_shutter_scan_delay[ i ] ÷
rsi_time_scale
}
```

Alternatively, an existing message, such as the shutter interval SEI message, may be extended by adding the syntax elements for the rolling shutter information SEI message discussed above. An example extended shutter interval SEI message is shown below:

| | Descriptor |
|---|---|
| shutter_interval_info( payloadSize ) { | |
| sii_time_scale | u(32) |
| sii_fixed_shutter_interval_within_clvs_flag | u(1) |
| if( fixed_shutter_interval_within_clvs_flag ) | |
| sii_num_units_in_shutter_interval | u(32) |
| else { | |
| sii_max_sub_layers_minus1 | u(3) |
| for( i = 0; i <= sii_max_sub_layers_minus1; i++ ) | |
| sii_sub_layer_num_units_in_shutter_interval[ i ] | u(32) |
| } | |
| [added: “if( more_data_in_payload( ) ) ”] | |
| [added: “if(payload_extension_present( )) {”] | |
| [added: “SeiExtensionBitsPresentFlag = 1”] | |
| [added: “sii_rolling_shutter_scan_order | u(32) ”] |
| [added: “if (sii_fixed_shutter_interval_within_clvs_flag) {”] | |
| [added: “sii_num_units_in_rolling_shutter_scan_interval | u(32) ”] |
| [added: “sii_num_units_in_rolling_shutter_scan_delay | u(32) ”] |
| [added: “}”] | |
| [added: “else {”] | |
| [added: “for( i = 0; i <= ssi_max_sub_layers_minus1; i++ ) ”] | |
| [added: | u(32) ”] |
| “sii_sub_layer_num_units_in_rolling_shutter_scan_interval[ i ] | |
| [added: | u(32) ”] |
| “sii_sub_layer_num_units_in_rolling_shutter_scan_delay[ i ] | |
| [added: “}”] | |
| [added: “}”] | |
| } | |

The rolling shutter information extension to the Shutter interval SEI message may indicate the scan interval for the associated video source pictures prior to encoding, e.g., for camera-captured content. The scan interval may be the amount of time between scanning the first pixel and the last pixel of a frame.

The semantics for these syntax elements may be as follows:
more_data_in_payload( ) represents a determination of whether the shutter interval SEI message includes data beyond either the sii_num_units_in_shutter_interval syntax element or the sii_sub_layer_num_units_in_shutter_interval[i] syntax element. In some examples, a flag syntax element, e.g., “rolling_shutter_information_present_flag” may be used to indicate whether the other added syntax elements for rolling shutter information are included in the shutter interval SEI message.
sii_rolling_shutter_scan_order indicates the rolling shutter scan order as specified in table X-2.

TABLE X-2

| sii_rolling_shutter_scan order | Scan order |
|---|---|
| 0 | Rolling shutter scans down pixels |
| | row by row from top to the bottom |
| | of the sensor |
| 1 | Rolling shutter scans up pixels |
| | row by row from bottom to the top |
| | of the sensor |
| 2 | Rolling shutter scans pixels |
| | column by column from left to the |
| | right of the sensor |
| 3 | Rolling shutter scans pixels |
| | column by column from right to |
| | the left of the sensor |

sii_num_units_in_rolling_shutter_scan_interval, when ssi_fixed_shutter_interval_within_clvs_flag is equal to 1, specifies the number of time units of a clock operating at the frequency ssi_time_scale Hz that corresponds to the indicated rolling shutter scan interval from first pixel to last pixel of each picture in the CLVS. The value 0 may be used to indicate that the associated video content contains screen capture content, computer generated content, or other non-camera-captured content.

The indicated rolling shutter scan interval, denoted by the variable rollingShutterScanInterval, in units of seconds, is equal to the quotient of ssi_num_units_in_rolling_shutter_scan_interval divided by ssi_time_scale. For example, to represent a rolling shutter scan interval equal to 0.04 seconds, ssi_time_scale may be equal to 27 000 000 and ssi_num_units_in_rolling_shutter_scan_interval may be equal to 1 080 000.
sii_num_units_in_rolling_shutter_scan_delay, when ssi_fixed_shutter_interval_within_clvs_flag is equal to 1, specifies the number of time units of a clock operating at the frequency ssi_time_scale Hz that corresponds to the indicated rolling shutter scan delay of the first pixel of each picture in the CLVS.

The indicated rolling shutter scan delay, denoted by the variable rollingShutterScanDelay, in units of seconds, is equal to the quotient of ssi_num_units_in_rolling_shutter_scan_delay divided by ssi_time_scale. For example, to represent a rolling shutter scan delay equal to 0.004 seconds, ssi_time_scale may be equal to 27 000 000 and ssi_num_units_in_rolling_shutter_scan_delay may be equal to 108 000.

sii_sub_layer_num_units_in_rolling_shutter_scan_interval[i], when present, specifies the number of time units of a clock operating at the frequency ssi_time_scale Hz that corresponds to the rolling shutter scan interval of each picture with temporal sublayer identifier equal to i in the CLVS. The rolling shutter scan interval for each picture with temporal sublayer identifier equal to i in the CLVS, denoted by the variable subLayerRollingShutterScanInterval[i], in units of seconds, is equal to the quotient of ssi_sub_layer_num_units_in_rolling_shutter_scan_interval[i] divided by ssi_time_scale.
sii_sub_layer_num_units_in_rolling_shutter_scan_delay[i], when present, specifies the number of time units of a clock operating at the frequency ssi_time_scale Hz that corresponds to the rolling shutter scan delay of each picture with temporal sublayer identifier equal to i in the CLVS. The rolling shutter scan delay for each picture with temporal sublayer identifier equal to i in the CLVS, denoted by the variable subLayerRollingShutterScanDelay[i], in units of seconds, is equal to the quotient of ssi_sub_layer_num_units_in_rolling_shutter_scan_delay[i] divided by ssi_time_scale.

The variables subLayerRollingShutterScanInterval[i] and subLayerRollingShutterScanDelay[i], corresponding to the indicated rolling shutter scan interval from first pixel to last pixel of each picture and rolling shutter scan delay of the first pixel of a frame with temporal sublayer identifier equal to i in the CLVS, is thus derived as follows:

```
if (ssi_fixed_shutter_interval_within_clvs_flag) {
  subLayerRollingShutterScanInterval[ i ] =
  ssi_num_units_in_rolling_shutter_scan_interval ÷ ssi_time_scale
  subLayerRollingShutterScanDelay[ i ] =
  ssi_num_units_in_rolling_shutter_scan_delay ÷ ssi_time_scale
}
else {
  subLayerRollingShutterScanInterval[ i ] =
  ssi_sub_layer_num_units_in_rolling_shutter_scan_interval[ i ] ÷
  ssi_time_scale
  subLayerRollingShutterScanDelay[ i ] =
  ssi_sub_layer_num_units_in_rolling_shutter_scan_delay[ i ] ÷
  ssi_time_scale
}
```

Additionally or alternatively, video encoders 324 and video decoders 332 may be configured to process a lens optical correction (LOC) SEI message as follows. An existing LOC SEI message may be extended by adding two additional distortion models, as shown below. The syntax may be modified to include these two models, and example semantics of the additional modes are defined below, where additions to existing syntax elements are indicated by “[added: “ ”]”.

| | Descriptor |
|---|---|
| lens_optical_correction( payloadSize ) { | |
| loc_cancel_flag | u(1) |
| if( !loc_cancel_flag ) { | |
| loc _persistence_flag | u(1) |
| loc_lens_model_present_flag | u(1) |
| if( loc_lens_model_present_flag ) { | |
| loc_reserved_zero_5bits | u(5) |
| loc_lens_model | st(v) |
| } | |
| loc_focal_parameters_present_flag | u(1) |
| if( loc_focal_parameters_present_flag ) { | |
| loc_focal_center_x | u(25) |
| loc_focal_center_y | u(25) |
| loc_focal_length | u(16) |
| } | |
| loc_rd_parameters_present_flag | u(1) |
| if( loc_rd_parameters_present_flag ) { | |
| loc_no_rd | u(1) |
| if( !loc_no_rd ) { | |
| loc_rd_model_id | u(8) |
| if( loc_rd_model_id = = 0 ) { | |
| loc_rd_poly3_k1 | i(25) |
| } | |
| if( loc_rd_model_id = = 1 ) { | |
| loc_rd_poly4_k1 | i(25) |
| loc_rd_poly4_k2 | i(25) |
| loc_rd_poly4_k3 | i(25) |
| loc_rd_poly4_k4 | i(25) |
| } | |
| if( loc_rd_model_id = = 2 ) { | |
| loc_rd_poly5_k1 | i(25) |
| loc_rd_poly5_k2 | i(25) |
| } | |
| [added: “if( loc_rd_model_id = = 3) {“] | |
| [added: “loc_rd_woodscape_poly_order_minus_4 | u(4)”] |
| [added: “for( i = 0; i < loc_rd_woodscape_poly_order_minus_4+4; | |
| i++ ) {”] | |
| [added: “loc_rd_woodscape_ki[i] | i(25)”] |
| [added: “}”] | |
| [added: “}”] | |
| [added: “if( loc_rd_model_id = = 4) {”] | |
| [added: “loc_focal_length_x | u(16)”] |
| [added: “loc_focal_length_y | u(16)”] |
| [added: “loc_rd_brown_conrady_k1 | i(25)”] |
| [added: “loc_rd_brown_conrady_k2 | i(25)”] |
| [added: “loc_rd_brown_conrady_k3 | i(25)”] |
| [added: “loc_td_parameters_present_flag | u(1)”] |
| [added: “if(loc_td_parameters_present_flag) {“] | |
| [added: “loc_td_brown_conrady_p1 | i(25)”] |
| [added: “loc_td_brown_conrady_p2 | i(25)”] |
| [added: “}”] | |
| [added: “}] | |
| [added: “}”] | |
| loc_tca_parameters_present_flag | u(1) |
| if( loc_tca_parameters_present_flag ) { | |
| loc_no_tca | u(1) |
| if( !loc_no_tca ) { | |
| loc_tca_model_id | u(8) |
| if( loc_tca_model_id = = 0 ) { | |
| loc_tca_kr | u(25) |
| loc_tca_kb | u(25) |
| } | |
| if( loc_tca_model_id = = 1 ) { | |
| loc_tca_br | i(25) |
| loc_tca_cr | i(25) |
| loc_tca_vr | u(25) |
| loc_tca_bb | i(25) |
| loc_tca_cb | i(25) |
| loc_tca_vb | u(25) |
| } | |
| } | |
| } | |
| loc_vignetting_parameters_present_flag | u(1) |
| if( loc_vignetting_parameters_present_flag ) { | |
| loc_no_vignetting | u(1) |
| if( !loc_no_vignetting ) { | |
| loc_vignetting_model_id | u(8) |
| if( loc_vignetting_model_id = = 0 ) { | |
| loc_vignetting_k1 | i(25) |
| loc_vignetting_k2 | i(25) |
| loc_vignetting_k3 | i(25) |
| } | |
| } | |
| } | |
| } | |
| } | |

The lens optical correction SEI message may provide video decoders 332 with a lens distortion model to enable image correction. When parameters for multiple distortion types are available in the lens optical correction SEI message, the parameters may be expressed with intention for correction in the following sequential order: first de-vignetting (if present), then anti-transversal chromatic aberration (TCA) (if present), then reversing the radial distortion (if present). Note: The parameters may be expressed such that the corrections can be applied to samples in linear RGB format. Pictures represented with YUV sample data (such as Y′CbCr) can be converted to linear RGB in order to apply the lens corrections as intended.

The parameters of this SEI message may apply to a cropped decoded picture.

Use of the lens optical correction SEI message may be premised upon having definitions for variables representing picture size (e.g., width and height), as follows: “A picture width and picture height in units of luma samples, denoted herein by PicWidthInLumaSamples and PicHeightInLumaSamples, respectively.”

When a frame packing arrangement SEI message is present in the CLVS, the parameters of this SEI message may apply to each constituent frame of the frame packing arrangement SEI message.

Semantics of the lens optical correction SEI message may be as follows:
loc_cancel_flag equal to 1 indicates that the SEI message cancels the persistence of any previous lens optical correction SEI message in output order that applies to the current layer. loc_cancel_flag equal to 0 indicates that lens optical correction follows.
loc_persistence_flag specifies the persistence of the lens optical correction SEI message for the current layer. loc_persistence_flag equal to 0 specifies that the lens optical correction SEI message applies to the current decoded picture only. loc_persistence_flag equal to 1 specifies that the lens optical correction SEI message applies to the current decoded picture and persists for all subsequent pictures of the current layer in output order until one or more of the following conditions are true:
   A new CLVS of the current layer begins.
   The bitstream ends.
   A picture in the current layer in an access unit (AU) associated with a lens optical correction SEI message is output that follows the current picture in output order.
loc_lens_model_present_flag equal to 1 indicates that the loc_lens_model syntax element is present in the lens optical correction SEI message syntax. loc_lens_model_present_flag equal to 0 indicates that the loc_lens_model syntax element is not present in the lens optical correction SEI message syntax.
loc_reserved_zero_5bits shall be equal to 0 in bitstreams conforming to this version of this Specification. The values greater than 0 for loc_reserved_zero_5bits are reserved for future use by ITU-T|ISO/IEC. Decoders shall also allow values greater than 0 for loc_reserved_zero_5bits to appear in the bitstream and shall ignore the value of loc_reserved_zero_5bits.
loc_lens_model specifies a string describing the applicable lens model.
loc_focal_parameters_present_flag equal to 1 indicates that focal parameters of the lens are present in the lens optical correction SEI message syntax. loc_focal_parameters_present_flag equal to 0 indicates that no focal parameter is present.
loc_focal_length defines the focal length of the lens, i.e., the distance from the lens in which rays of light that fall parallel to the optical axis into the lens are converged. It is expressed in units of 0.1 millimeters. A value of 0 indicates that the focal length is undefined. When not present, the value of loc_focal_length is inferred to be equal to 0.
loc_focal_center_x÷2²⁴ defines the horizontal location in the picture of the focal point expressed as a ratio of the picture width. When not present, the value of loc_focal_center_x is inferred to be equal to 2²³ which corresponds to the center of the picture horizontally. The value of loc_focal_center_x shall be in the range of 0 to 2²⁴ inclusive.
loc_focal_center_y÷2²⁴ defines the vertical location in the picture of the focal point expressed as a ratio of the picture height. When not present, the value of loc_focal_center_y is inferred to be equal to 2²³ which corresponds to the center of the picture vertically. The value of loc_focal_center_y shall be in the range of 0 to 2²⁴, inclusive.
loc_rd_parameters_present_flag equal to 1 indicates that radial distortion parameters are present in the lens optical correction SEI message syntax. loc_rd_parameters_present_flag equal to 0 indicates that radial distortion parameters are not present in the lens optical correction SEI message syntax.
loc_no_rd equal to 1 indicates that there is no radial distortion. loc_no_rd equal to 0 indicates that radial distortion information is provided by the radial distortion parameters in the lens optical correction SEI message.
loc_rd_model_id identifies the type of radial distortion model as specified in Table 1. The value of loc_rd_model_id shall be in the range of 0 to 4, inclusive. The values greater than 4 are reserved for future use by ITU-T|ISO/IEC and shall not be present in bitstreams conforming to this version of this Specification. Decoders shall ignore lens optical correction SEI messages with loc_rd_model_id greater than 4.

TABLE 1
loc_rd_model_id

| Value | Description |
|---|---|
| 0 | Poly3 |
| 1 | Poly4 |
| 2 | Poly5 |
| [added: “3 | Woodscape”] |
| [added: “4 | Brown-Conrady”] |

Normalized coordinates may be computed from pixel coordinates by scaling by the relevant focal length parameter when defined. If the focal length parameter is undefined the normalized coordinates are undefined. Given pixel coordinates (r,j) and focal length parameters loc_focal_length_x and loc_focal_length_y the conversion to and from normalized coordinates is defined by:

x_{normalized}=j÷loc_focal_length_x

y_{normalized}=i÷loc_focal_length_x

j=x_{normalized}*loc_focal_length_x

i=y_{normalized}*loc_focal_length_y

r_{normalized}=sqrt(x_{normalized}*x_{normalized}+y_{normalized}*y_{normalized})

When loc_rd_model_id equals to 0, the polynomial 3^{rd} order (Poly3) model is specified as:

r_{d}=rᵤ*(1−k₁+k₁*rᵤ*rᵤ) (X-1)
with r_{d} referring to the distorted radius (normalized distance to image center), rᵤ referring to the corrected undistorted radius, and k₁ being the distortion coefficient.

When loc_rd_model_id equals to 1, the polynomial 4^{th} order (Poly4) model is specified as

r_{d}=rᵤ*(k₁+k₂*rᵤ+k₃*rᵤ*rᵤ+k₄*rᵤ*rᵤ*rᵤ) (X-2)
with r_{d} referring to the distorted radius (normalized distance to image center), rᵤ referring to the corrected undistorted radius, and k₁, k₂, k₃ and k₄ being the distortion coefficients.
NOTE—Lenses with radial distortion information expressed using a three parameter formula of the form the r_{d}=rᵤ*(ar³ᵤ+br²ᵤ+crᵤ+1−a−b−c), can be signalled with Poly4 parameters by setting k₁=1−a−b−c, k₂=c, k₃=b, k₄=a.

When loc_rd_model_id equals to 2 the polynomial 5^{th} (Poly5) order model is specified as

r_{d}=rᵤ*(1−k₁*rᵤ*rᵤ+k₂*rᵤ*rᵤ*rᵤ*rᵤ) (X-3)

with rd referring to the distorted radius (normalized distance to image center), ru referring to the corrected undistorted radius, and k1 and k₂ being the distortion coefficients.
loc_rd_poly3_k1÷2²⁴ indicates the value of the k1 parameter from the Poly3 radial distortion model from equation (X-1). When not present, the value of loc_rd_poly3_k1 is inferred to be equal to 0.
loc_rd_poly4_k1÷2²⁴ indicates the value of the k₁ parameter from the Poly4 radial distortion model from equation (X-2). When not present, the value of loc_rd_poly4_k1 is inferred to be equal to 0.
loc_rd_poly4_k2÷2²⁴ indicates the value of the k₂ parameter from the Poly4 radial distortion model from equation (X-2). When not present, the value of loc_rd_poly4_k2 is inferred to be equal to 0.
loc_rd_poly4_k3÷2²⁴ indicates the value of the k₃ parameter from the Poly4 radial distortion model from equation (X-2). When not present, the value of loc_rd_poly4_k3 is inferred to be equal to 0.
loc_rd_poly4_k4÷2²⁴ indicates the value of the k₄ parameter from the Poly4 radial distortion model from equation (X-2). When not present, the value of loc_rd_poly4_k4 is inferred to be equal to 0.
loc_rd_poly5_k1÷2²⁴ indicates the value of the k1 parameter from the Poly5 radial distortion model from equation (X-2). When not present, the value of loc_rd_poly5_k1 is inferred to be equal to 0.
loc_rd_poly5_k2÷2²⁴ indicates the value of the k2 parameter from the Poly5 radial distortion model from equation (X-2). When not present, the value of loc_rd_poly5_k2 is inferred to be equal to 0.

When loc_rd_model_id equals to 3 a polynomial n^{th} order model is specified as relating angle theta and radius by:

$$r = {\sum }_{i = 1}^{n} {k}_{i} \cdot {theta}^{i} \qquad ( X - 4 )$$

Where theta is the angle of incidence with respect to the optical axis and rho is the distance between the image center and projected point.

loc_rd_woodscape_poly_order_minus_4 plus 4 specifies the number of coefficients of this model, the value of n in (X-4), The value of loc_rd_woodscape_num_coefficients_minus_4 shall be in the range 0 to 8 inclusive.
loc_rd_woodscape_ki[i]÷2¹⁰ indicates the value of the kᵢ₊₁ parameter from the radial distortion model from equation (X-4). When not present, the value of loc_rd_woodscape_ki[i] is inferred to be equal to 0.

When loc_rd_model_id equals to 4, the lens distortion model is specified with 5 parameters k₁, k₂, k₃, p₁, p₂.

The total distortion is the cascade of radial and tangential distortions.

$${x}_{1} = x ( 1 + {k}_{1} {r}^{2} + {k}_{2} {r}^{4} + {k}_{3} {r}^{6} ) \qquad ( X - 5 )$$

$${y}_{1} = y ( 1 + {k}_{1} {r}^{2} + {k}_{2} {r}^{4} + {k}_{3} {r}^{6} )$$

$${r}_{1} = r ( 1 + {k}_{1} {r}^{2} + {k}_{2} {r}^{4} + {k}_{3} {r}^{6} )$$

$${x}_{2} = {x}_{1} + [ 2 {p}_{1} {x}_{1} {y}_{1} + {p}_{2} ( {r}_{1}^{2} + 2 {x}_{1}^{2} ) ] \qquad ( X - 6 )$$

$${y}_{2} = {y}_{1} + [ {p}_{1} ( {r}_{1}^{2} + 2 {y}_{1}^{2} ) + 2 {p}_{2} {x}_{1} {y}_{1} ]$$

loc_rd_brown_conrady_k1÷2²⁴ indicates k₁ parameter from distortion model from equation (X-5). When not present, the value of loc_rd_brown_conrady_k1 is inferred to be equal to 0.
loc_rd_brown_conrady_k2÷2²⁴ indicates k₂ parameter from distortion model from equation (X-5). When not present, the value of loc_rd_brown_conrady_k2 is inferred to be equal to 0.
loc_rd_brown_conrady_k3÷2²⁴ indicates k₃ parameter from distortion model from equation (X-5). When not present, the value of loc_rd_brown_conrady_k3 is inferred to be equal to 0.
loc_td_parameters_present_flag indicates the presence of tangential distortion parameters.
loc_td_brown_conrady_p1÷2²⁴ indicates p₁ parameter from distortion model from equation (X-6). When not present, the value of loc_td_brown_conrady_p1 is inferred to be equal to 0.
loc_td_brown_conrady_p2÷2²⁴ indicates p₂ parameter from distortion model from equation (X-6). When not present, the value of loc_td_brown_conrady_p2 is inferred to be equal to 0.
loc_tca_parameters_present_flag equal to 1 indicates that transversal chromatic aberration parameters are present in the lens optical correction SEI message syntax. loc_tca_parameters_present_flag equal to 0 indicates that transversal chromatic aberration parameters are not present in the lens optical correction SEI message syntax.
loc_no_tca equal to 1 indicates that there is no transversal chromatic aberration. loc_no_tca equal to 0 indicates that transversal chromatic aberration information is provided by the transversal chromatic aberration parameters in the lens optical correction SEI message.
loc_tca_model_id identifies the type of radial distortion model as specified in Table 2. The value of loc_tca_model_id shall be in the range of 0 to 1, inclusive. The values greater than 1 are reserved for future use by ITU-T|ISO/IEC and shall not be present in bitstreams conforming to this version of this Specification. Decoders shall ignore lens optical correction SEI messages with loc_tca_model_id greater than 1.

TABLE 2
loc_tca_model_id

| Value | Description |
|---|---|
| 0 | Linear |
| 1 | Poly3 |

When loc_tca_model_id equals to 0 the linear model is specified as:

r_{d,R}=r_{u,R}*k_{R} (X-3)

r_{d,B}=r_{u,B}*k_{B} (X-4)

with r_{d,R} and r_{d,B} referring to the distorted radius (normalized distance to image center) of the red and blue components respectively, r_{u,R} and r_{u,B} referring to the corrected undistorted radius of the red and blue components respectively, and k_{R} and k_{B} being the transversal chromatic aberration coefficients of the red and blue components respectively. Note: The transversal chromatic aberration is corrected in the linear model on the red and blue components with the green component as the reference.

When loc_tca_model_id equals to 1 the polynomial 3^{rd} order (Poly3) model is specified as

r_{d,R}=r_{u,R}*(b_{R}*r_{u,R}*r_{u,R}+c_{R}*r_{u,R}+v_{R}) (X-5)

r_{d,B}=r_{u,B}*(b_{B}*r_{u,B}*r_{u,B}+c_{B}*r_{u,B}+v_{B}) (X-6)

with r_{d,R} and r_{d,B} referring to the distorted radius (normalized distance to image center) of the red and blue components respectively, r_{u,R} and r_{u,B} referring to the corrected undistorted radius of the red and blue components respectively, and {b_{R}, c_{R}, v_{R}} and {b_{B}, c_{B}, v_{B}}being the transversal chromatic aberration coefficients of the red and blue components respectively. Note: The transversal chromatic aberration is corrected in the Poly3 model on the red and blue components with the green component as the reference.
loc_tca_kr÷2²⁴ indicates the value of the kR parameter from the linear transversal chromatic aberration model from equation (X-3). When not present, the value of loc_tca_kr is inferred to be equal to 2²⁴
loc_tca_kb÷2²⁴ indicates the value of the k_{B} parameter from the linear transversal chromatic aberration model from equation (X-4). When not present, the value of loc_tca_kr is inferred to be equal to 2²⁴
loc_tca_br÷2²⁴ indicates the value of the b_{B} parameter from the Poly3 transversal chromatic aberration model from equation (X-5). When not present, the value of loc_tca_br is inferred to be equal to 0.
loc_tca_cr÷2²⁴ indicates the value of the c_{R} parameter from the Poly3 transversal chromatic aberration model from equation (X-5). When not present, the value of loc_tca_cr is inferred to be equal to 0.
loc_tca_vr÷2²⁴ indicates the value of the v_{R} parameter from the Poly3 transversal chromatic aberration model from equation (X-5). When not present, the value of loc_tca_yr is inferred to be equal to 2²⁴
loc_tca_bb÷2²⁴ indicates the value of the bB parameter from the Poly3 transversal chromatic aberration model from equation (X-6). When not present, the value of loc_tca_bb is inferred to be equal to 0.
loc_tca_cb÷2²⁴ indicates the value of the cB parameter from the Poly3 transversal chromatic aberration model from equation (X-6). When not present, the value of loc_tca_cb is inferred to be equal to 0.
loc_tca_vb÷2²⁴ indicates the value of the vs parameter from the Poly3 transversal chromatic aberration model from equation (X-6). When not present, the value of loc_tca_vb is inferred to be equal to 2²⁴
loc_vignetting_parameters_present_flag equal to 1 indicates that vignetting parameters are present in the lens optical correction SEI message syntax. loc_vignetting_parameters_present_flag equal to 0 indicates that vignetting parameters are not present in the lens optical correction SEI message syntax.
loc_no_vignetting equal to 1 indicates that there is vignetting. loc_no_vignetting equal to 0 indicates that vignetting information is provided by the vignetting parameters in the lens optical correction SEI message.
loc_vignetting_model_id identifies the type of vignetting model as specified in Table 1. The value of loc_vignetting_model_id shall be equal to 0. The values greater than 0 are reserved for future use by ITU-T|ISO/IEC and shall not be present in bitstreams conforming to this version of this Specification. Decoders shall ignore lens optical correction SEI messages with loc_vignetting_model_id greater than 0.

TABLE 3_
loc_vignetting_model_id

| Value | Description |
|---|---|
| 0 | Poly6 |

When loc_vignetting_model_id equals to 0, the polynomial 6^{th} order (Poly6) model is specified as:

c_{d}=cₛ*(1+k₁*rᵤ*rᵤ+k₂*rᵤ*rᵤ*rᵤ*rᵤ+k₃*rᵤ*rᵤ*rᵤ*rᵤ*rᵤ*rᵤ) (X-2)

with c_{d} referring to the distorted colour, cₛ referring to the undistorted colour, rᵤ referring to the radius, and k₁, k₂ and k₃ being the vignetting distortion coefficients. Note: The same vignetting parameters are used for red, green and blue.
loc_vignetting_k1÷2²⁴ indicates the value of the k₁ parameter from the Poly6 vignetting model from equation (X-2). When not present, the value of loc_vignetting_k1 is inferred to be equal to 0.
loc_vignetting_k2÷2²⁴ indicates the value of the k₂ parameter from the Poly6 vignetting model from equation (X-2). When not present, the value of loc_vignetting_k2 is inferred to be equal to 0.
loc_vignetting_k3÷2²⁴ indicates the value of the k₃ parameter from the Poly6 vignetting model from equation (X-2). When not present, the value of loc_vignetting_k3 is inferred to be equal to 0.

Alternatively, in the syntax table for the modified lens optical correction SEI message above, the loc_focal_parameters_present_flag syntax element may instead be named, “loc_focal_center_present_flag.” Then the “if” conditional following the loc_focal_center_present_flag may be, “if (loc_focal_parameters_present_flag) {.” Moreover, the focal length may be specified separately from the center, e.g., using a syntax element “lc_focal_length_present_flag.” When true, focal length values may be expressed using respective x- and y-values. These revisions are shown below:

| | |
|---|---|
| loc_focal_center_present_flag | u(1) |
| if( loc_focal_center_present_flag | |
| loc_focal_center_x | u(25) |
| loc_focal_center_y | u(25) |
| } | |
| loc_focal_length_present_flag | u(1) |
| if( loc_focal_length_present_flag ) { | |
| loc_focal_length_x | u(16) |
| loc_focal_length_y | u(16) |
| } | |

Thus, the lens optical correction SEI message syntax may be as follows:

| | Descriptor |
|---|---|
| lens_optical_correction( payloadSize ) { | |
| loc_cancel_flag | u(1) |
| if( !loc_cancel_flag ) { | |
| loc _persistence_flag | u(1) |
| loc_lens_model_present_flag | u(1) |
| if( loc_lens_model_present_flag ) { | |
| loc_reserved_zero_5bits | u(5) |
| loc_lens_model | st(v) |
| } | |
| loc_pic_width_in_luma_samples | ue(v) |
| loc_pic_height_in_luma_samples | ue(v) |
| loc_focal_center_present_flag | u(1) |
| if( loc_focal_center_present_flag ) { | |
| loc_focal_center_x | u(25) |
| loc_focal_center_y | u(25) |
| } | |
| loc_focal_length_present_flag | u(1) |
| if( loc_focal_length_present_flag ) { | |
| loc_focal_length_x | u(16) |
| loc_focal_length_y | u(16) |
| } | |
| loc_rd_parameters_present_flag | u(1) |
| if( loc_rd_parameters_present_flag ) { | |
| loc_no_rd | u(1) |
| if( !loc_no_rd ) { | |
| loc_rd_model_id | u(8) |
| if( loc_rd_model_id = = 0 ) { | |
| loc_rd_poly3_k1 | i(25) |
| } | |
| if( loc_rd_model_id = = 1) { | |
| loc_rd_poly4_k1 | i(25) |
| loc_rd_poly4_k2 | i(25) |
| loc_rd_poly4_k3 | i(25) |
| loc_rd_poly4_k4 | i(25) |
| } | |
| if( loc_rd_model_id = = 2 ) { | |
| loc_rd_poly5_k1 | i(25) |
| loc_rd_poly5_k2 | i(25) |
| } | |
| if( loc_rd_model_id = = 3) { | |
| loc_rd_woodscape_poly_order_minus_4 | u(4) |
| for( i = 0; i < loc_rd_woodscape_ poly_order_minus_4+4; | |
| i++ ) { | |
| loc_rd_woodscape_ki[i] | i(25) |
| } | |
| } | |
| if( loc_rd_model_id = = 4) { | |
| loc_focal_length_x | u(16) |
| loc_focal_length_y | u(16) |
| loc_rd_brown_conrady_k1 | i(25) |
| loc_rd_brown_conrady_k2 | i(25) |
| loc_rd_brown_conrady_k3 | i(25) |
| loc_td_parameters_present_flag | u(1) |
| if(loc_td_parameters_present_flag) { | |
| loc_td_brown_conrady_p1 | i(25) |
| loc_td_brown_conrady_p2 | i(25) |
| } | |
| } | |
| } | |
| loc_tca_parameters_present_flag | u(1) |
| if( loc_tca_parameters_present_flag ) { | |
| loc_no_tca | u(1) |
| if( !loc_no_tca ) { | |
| loc_tca_model_id | u(8) |
| if( loc_tca_model_id = = 0 ) { | |
| loc_tca_kr | u(25) |
| loc_tca_kb | u(25) |
| } | |
| if( loc_tca_model_id = = 1 ) { | |
| loc_tca_br | i(25) |
| loc_tca_cr | i(25) |
| loc_tca_vr | u(25) |
| loc_tca_bb | i(25) |
| loc_tca_cb | i(25) |
| loc_tca_vb | u(25) |
| } | |
| } | |
| } | |
| loc_vignetting_parameters_present_flag | u(1) |
| if( loc_vignetting_parameters_present_flag ) { | |
| loc_no_vignetting | u(1) |
| if( !loc_no_vignetting ) { | |
| loc_vignetting_model_id | u(8) |
| if( loc_vignetting_model_id = = 0 ) { | |
| loc_vignetting_k1 | i(25) |
| loc_vignetting_k2 | i(25) |
| loc_vignetting_k3 | i(25) |
| } | |
| } | |
| } | |
| } | |
| } | |

Semantics for these syntax elements may be as follows:
loc_focal_length_present_flag equal to 1 indicates that focal length of the lens is present in the lens optical correction SEI message syntax. loc_focal_length_present_flag equal to 0 indicates that no focal length is present.
loc_focal_length_x defines the focal length of the lens in the horizontal direction in units of pixels. A value of 0 indicates that the focal length is undefined. When not present, the value of loc_focal_length is inferred to be equal to 0.
loc_focal_length_y defines the focal length of the lens in the vertical direction in units of pixels. A value of 0 indicates that the focal length is undefined. When not present, the value of loc_focal_length is inferred to be equal to 0. In practice, the horizontal focal length and the vertical focal length of a camera may differ for a variety of reasons, resulting in an image having non-square pixels. For example, a digital camera sensor used to capture the video data may include manufacturing flaws that cause non-square pixels, or the image may have been non-uniformly scaled during a post-processing stage. Additionally, the camera lens itself may introduce unintentional distortion, or the camera may utilize an anamorphic format where the lens compresses a widescreen scene into a standard-sized sensor. Furthermore, errors during the camera calibration process may result in differing estimations for the horizontal and vertical focal lengths. By signaling both a horizontal focal length and a vertical focal length in the SEI message, a video decoder or post-processing unit can accurately account for these variations during image rectification or depth estimation.

In all models, the normalized coordinates xₙ and yₙ may be computed by subtracting the position of the image center, in pixels from the pixel coordinates i and j, and by dividing the horizontal pixel coordinate loc_focal_length_x and the vertical pixel coordinate by the value of loc_focal_length_y. When loc_focal_length_x or loc_focal_length_y is undefined, the normalized coordinates are also undefined.

cx=(loc_focal_center_x÷2²⁴)*PicWidthInLumaSamples

cy=(loc_focal_center_y÷2²⁴)*PicHeightInLumaSamples

xₙ=(i+1−cx)+loc_focal_length_x

i=loc_focal_length_x*xₙ+cx

y₁=(j+1−cy)÷loc_focal_length_y

j=loc_focal_length_y*yₙ+cy

rₙ=sgrt(xₙ*xₙ+yₙ*yₙ)

Additionally or alternatively, video encoders 324 and video decoders 332 may process a camera extrinsics information SEI message. The camera extrinsics information SEI message may provide a mechanism to signal a coordinate system and supports three common ways of specifying a rotation: quaternions, 3×3 rotation matrix, or Euler angles. An example syntax for the camera extrinsics information SEI message is shown below:

| | Descriptor |
|---|---|
| camera_extrinsics_info( payloadSize ) { | |
| cei_coordinate_system_idc | u(2) |
| cei_rotation_format_id | u(2) |
| if(cei_rotation_format_id == 0) { | |
| cei_quaternion_scalar_first_flag | u(1) |
| for( i = 0; i < 4; i++ ) { | |
| cei_quaternion_sign[i] | u(1) |
| cei_quaternion_exponent[i] | u(7) |
| cei_quaternion_mantissa[i] | u(23) |
| } | |
| if(cei_rotation_format_id == 1) { | |
| for( k = 0; k < 3; k++ ) { /* column */ | |
| sign_r[ i ][ j ][ k ] | u(1) |
| exponent_r[ i ][ j ][ k ] | u(7) |
| mantissa_r[ i ][ j ][ k ] | u(23) |
| } | |
| if(cei_rotation_format_id == 2) { | |
| yaw_rotation | i(32) |
| pitch_rotation | i(32) |
| roll_rotation | i(32) |
| } | |
| for( i = 0; i < 3; i++ ) { | |
| cei_translation[i] | u(15) |
| } | |
| } | |

Semantics for the syntax elements of the example camera extrinsics information SEI message above may be as follows:
cei_coordinate_system_idc indicator of coordinate system used. A value of zero corresponds to ISO 8855 vehicle coordinate system where the X axis is parallel to the vehicle's heading and is in the forward direction of the vehicle. The Y axis is perpendicular to the X axis and is in the left direction of the vehicle. The Z axis is perpendicular to the X and Y axes and is in the up direction of the vehicle. A value of 1 corresponds to a camera centric coordinate system coordinate system where the X-axis extends to the right and the Y-axis down, following the usual image coordinate space. The Z-axis points out of the camera, towards the scene. (OpenCV). Values equal to or greater than 2 are reserved.
cei_rotation_format_id indicates the format used to describe rotations according to table 4. The value of cei_rotation_format_id shall be in the range 0 to 3 inclusive.

TABLE 4
cei_rotation_format_id

| Value | Description |
|---|---|
| 0 | Quaternions |
| 1 | 3x3 rotation matrix |
| 2 | Euler Angles |
| 3 | Reserved |

cei_quaternion_scalar_first_flag: Indicates order of quaternion component values. A single quaternion has four components and is expressed in the basis of unit quaternions {1, i, j, k} as Q=W+X*i+Y*j+Z*k. The component W is referred to as the scalar component. Two orders are used for the quaternion components either having W first or last. The flag cei_quaternion_scalar_first_flag indicates these orders with a value of zero corresponding to scalar component last and a value of 1 indicating the scalar component is first.
cei_quaternion_sign[i] indicates the sign of value of the i^{th} quaternion component.
cei_quaternion_exponent[i] indicates the exponent of the value of i^{th} quaternion component.
cei_quaternion_mantissa[i] indicates the mantissa of the value of i^{th} quaternion component.

The four quaternion components are reconstructed as equal to (−1)^{sign}*2^{exponent-127}*(1+mantissa÷2²³). The quaternion components shall not be all zero. The quaternion should be normalized to produce a unit quaternion defining a rotation relative to the coordinate system indicated by cei_coordinate_system_idc. In some examples, three quaternion components are signaled and the fourth may be derived from the normalization constraint that the sum of squares is one. The fourth quaternion component q3 may be reconstructed from the three signaled quaternion components q0 to q2 as follows: q₃=\sqrt{1−(q₀²+q₁²+q₂²)}. Quaternions (q₀,q₁,q₂,q₃) and (−q₀,−q₁,−q₂,−q₃) represent the same 3D rotation, so an encoder can select the quaternion to signal with nonnegative q₃ component by negating all components as needed. The parameters of the quaternion may be determined such that q₀²+q₁²+q₂²≤1.
sign_r[j][k] equal to 0 indicates that the sign of (j, k) component of the rotation matrix is positive. sign_r[j][k] equal to 1 indicates that the sign is negative.
exponent_r[j][k] specifies the exponent part of (j, k) component of the rotation matrix. The value of exponent_r[j][k] shall be in the range of 0 to 127, inclusive.
mantissa_r[j][k] specifies the mantissa part of (j, k) component of the rotation matrix. The length of the mantissa_r[j][k] syntax element in units of bits is 23:

The rotation matrix R is represented as follows:

$$R = [ \begin{matrix}rE [ 0 ] [ 0 ] & rE [ 0 ] [ 1 ] & rE [ 0 ] [ 2 ] \\ rE [ 1 ] [ 0 ] & rE [ 1 ] [ 1 ] & rE [ 1 ] [ 2 ] \\ rE [ 2 ] [ 0 ] & rE [ 2 ] [ 1 ] & rE [ 2 ] [ 2 ]\end{matrix} ] \qquad ( X - N )$$

where rE[j][k]=(−1)^{sign_r[j][k]}2^{exponent}^{_{r[j][k]}}⁻¹²⁷(1+mantissa_r[j][k]÷2²³).
The rotation matrix should be a special orthogonal matrix to describe a rotation i.e.

R^{T}R=I,det(R)=+1.
yaw_rotation specifies the value of the yaw rotation angle, in units of 2⁻¹⁶ degrees. The value of yaw rotation shall be in the range of −180*2¹⁶ (i.e., −11 796 480) to 180*2¹⁶−1 (i.e., 11 796 479), inclusive. When not present, the value of yaw rotation is inferred to be equal to 0.
pitch_rotation specifies the value of the pitch rotation angle, in units of 2⁻¹⁶ degrees. The value of pitch_rotation shall be in the range of −90*2¹⁶ (i.e., −5 898 240) to 90*2¹⁶ (i.e., 5 898 240), inclusive. When not present, the value of pitch rotation is inferred to be equal to 0.
roll_rotation specifies the value of the roll rotation angle, in units of 2⁻¹⁶ degrees. The value of roll_rotation shall be in the range of −180*2¹⁶ (i.e., −11 796 480) to 180*2¹⁶−1 (i.e., 11 796 479), inclusive. When not present, the value of roll_rotation is inferred to be equal to 0.
cei_translation[i]−2¹⁴ indicates the i^{th} component of translation vector relative to origin of coordinate system specified by cei_coordinate_system_idc in millimeters.

Alternatively, the signed values in the bitstream i(n) can be replaced by a pair of a single bit sign and a magnitude u(n−1).

Alternatively, the translation may be specified with a precision field and the value defined by multiplying the precision field by the cei_translation[ ] values.

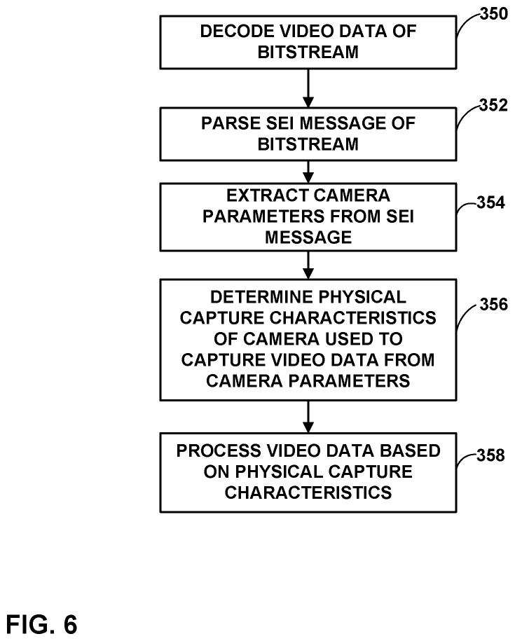

FIG. 6 is a flowchart illustrating an example method of processing video data using a supplemental enhancement information (SEI) message per techniques of this disclosure. One or more video decoders, such as video decoders 332 of FIG. 5, may perform the method of FIG. 6. Video decoders 332 decode video data of a bitstream to form decoded video data (350). The bitstream includes the video data and a supplemental enhancement information (SEI) message. The SEI message includes one or more camera parameters for a camera used to capture the video data. Video decoders 332 parse the SEI message of the bitstream (352) and extract the one or more camera parameters from the SEI message (354). A processing system, such as model generation unit 336 or ADAS controller 120, determines physical capture characteristics of the camera used to capture the video data from the one or more camera parameters (356). The physical capture characteristics may comprise a scan interval of a rolling shutter of the camera. The SEI message may comprise a shutter interval information SEI message including a rolling shutter information extension. The rolling shutter information extension includes the scan interval of the rolling shutter of the camera. The one or more camera parameters may comprise a syntax element specifying a rolling shutter scan order. The rolling shutter scan order represents one of a top-to-bottom scan order, a bottom-to-top scan order, a left-to-right scan order, or a right-to-left scan order. The one or more camera parameters may comprise syntax elements representing a scan interval and a scan delay for each of a plurality of temporal sublayers in a coded layer video sequence (CLVS) of the video data.

The physical capture characteristics may include an optical distortion of a lens of the camera. The optical distortion may represent a radial distortion model such as an angle polynomial model or a Brown-Conrady model. When the radial distortion model includes the angle polynomial model, the camera parameters may indicate a number of coefficients of the angle polynomial model and a floating-point value for each coefficient of the angle polynomial model. When the radial distortion model includes the Brown-Conrady model, the camera parameters may include at least one tangential distortion parameter. The camera parameters may include separate horizontal focal lengths and vertical focal lengths. The camera parameters may include a horizontal focal center and a vertical focal center.

The physical capture characteristics may include a spatial pose of the camera in a three-dimensional space. The one or more camera parameters may include a coordinate system indicator specifying one of a vehicle-centric coordinate system or a camera-centric coordinate system. The spatial pose may include a camera orientation. The camera parameters may indicate the camera orientation by one of unit quaternions, a rotation matrix, or Euler angles. When the camera parameters indicate the camera orientation by unit quaternions, the camera parameters include data representing a sign, an exponent, and a mantissa for each component of a quaternion. When the camera parameters indicate the camera orientation by the rotation matrix, the camera parameters may include data representing a sign, an exponent, and a mantissa for each component of a 3×3 rotation matrix. The camera parameters may include a three-component translation vector representing a translation relative to an origin of a world coordinate system.

The processing system may process the decoded video data based on the physical capture characteristics to form processed video data (358). The processing system may process the decoded video data based on the physical capture characteristics. The processing system may provide the processed video data to an advanced driver assistance system (ADAS). The ADAS may use the processed video data to detect objects and perform driving assistance tasks.

In this manner, the method of FIG. 6 represents an example of a method of processing video data, including: decoding video data of a bitstream to form decoded video data, the bitstream including the video data and a supplemental enhancement information (SEI) message including one or more camera parameters for a camera used to capture the video data; extracting the one or more camera parameters from the SEI message; determining physical capture characteristics of the camera used to capture the video data from the one or more camera parameters; and processing the decoded video data based on the physical capture characteristics to form processed video data.

Various examples of the techniques of this disclosure are summarized in the following clauses:

Clause 1. A method of processing video data, the method comprising: encoding or decoding video data; and processing a supplemental enhancement information (SEI) message including rolling shutter information representing a scan interval for a video source that captured the video data, the scan interval representing an amount of time between scanning a first pixel and a last pixel of a frame of the video data.

Clause 2. The method of clause 1, wherein the SEI message comprises a rolling shutter information SEI message.

Clause 3. The method of clause 1, wherein the SEI message comprises a shutter interval SEI message including a rolling shutter extension, the rolling shutter extension including the rolling shutter information.

Clause 4. The method of any of clauses 1-3, wherein the rolling shutter information includes syntax elements representing a rolling shutter scan order.

Clause 5. The method of any of clauses 1-4, wherein when the rolling shutter information includes data indicating that an interval and a delay are the same for all temporal layers in a coded layer video sequence (CLVS) of the video data, the rolling shutter information further includes syntax elements representing the interval and the delay.

Clause 6. The method of any of clauses 1-4, wherein when the rolling shutter information includes data indicating that an interval and a delay are not the same for all temporal layers in a coded layer video sequence (CLVS) of the video data, the rolling shutter information further includes syntax elements representing, for each of the temporal layers, a respective interval and a respective delay.

Clause 7. A method of processing video data, the method comprising: encoding or decoding video data; and processing a supplemental enhancement information (SEI) message including data for at least one of a Woodscape optical distortion model or a Brown-Conrady optical distortion model.

Clause 8. A method comprising a combination of the method of any of clauses 1-6 and the method of clause 7.

Clause 9. The method of any of clauses 7 and 8, wherein the SEI message includes the data for the Woodscape optical distortion model, including data indicating a number of coefficients for the Woodscape optical distortion model and, for each of the number of coefficients, a value of a corresponding parameter from a radial distortion model for the Woodscape optical distortion model.

Clause 10. The method of any of clauses 7 and 8, wherein the SEI message includes the data for the Brown-Conrady optical distortion model, including data representing values for parameters of the Brown-Conrady optical distortion model.

Clause 11. The method of clause 10, wherein the SEI message further includes data representing tangential distortion parameters of the Brown-Conrady optical distortion model.

Clause 12. The method of any of clauses 8-11, wherein the SEI message further includes data indicating whether focal length data is included in the SEI message, and when the data indicates that the focal length data is included in the SEI message, the SEI message further includes the focal length data.

Clause 13. The method of any of clauses 8-12, wherein the SEI message further includes data indicating whether focal center data is included in the SEI message, and when the data indicates that the focal center data is included in the SEI message, the SEI message further includes the focal center data.

Clause 14. A method of processing video data, the method comprising: encoding or decoding video data; and processing a supplemental enhancement information (SEI) message including camera extrinsics information representing a coordinate system and a format for indicating rotation data within the coordinate system for a camera used to capture the video data.

Clause 15. A method comprising a combination of the method of any of clauses 1-13 and the method of clause 14.

Clause 16. The method of any of clauses 14 and 15, wherein the format for indicating the rotation data comprises a quaternion, and wherein the SEI message further includes data indicating an order for components of the quaternion and, for each of the components, data representing a sign, an exponent, and a mantissa for the component.

Clause 17. The method of any of clauses 14 and 15, wherein the format for indicating the rotation data comprises a 3×3 rotation matrix, and wherein the SEI message further includes, for each component of the 3×3 rotation matrix, data representing a sign, an exponent, and a mantissa for the component.

Clause 18. The method of any of clauses 14 and 15, wherein the format for indicating the rotation data comprises Euler angles, and wherein the SEI message further includes data representing a yaw rotation, a pitch rotation, a roll rotation, and data for components of a translation vector.

Clause 19. The method of any of clauses 1-18, wherein the method comprises encoding the video data, and wherein processing comprises generating the SEI message.

Clause 20. The method of any of clauses 1-18, wherein the method comprises decoding the video data, and wherein processing comprises parsing the SEI message.

Clause 21. The method of clause 20, further comprising providing decoded video data and parameters from the SEI message to an advanced driver assistance system (ADAS) model generation unit.

Clause 22. A device for processing video data, the device comprising one or more means for performing the method of any of clauses 1-21.

Clause 23. The device of clause 22, wherein the one or more means comprise a memory configured to store video data and a processing system comprising one or more processors implemented in circuitry.

Clause 24. A computer-readable storage medium having stored thereon instructions that, when executed, cause a processor to perform the method of any of clauses 1-21.

Clause 25. A device for processing video data, the device comprising: means for encoding or decoding video data; and means for processing a supplemental enhancement information (SEI) message including rolling shutter information representing a scan interval for a video source that captured the video data, the scan interval representing an amount of time between scanning a first pixel and a last pixel of a frame of the video data.

Clause 26. A device for processing video data, the device comprising: means for encoding or decoding video data; and means for processing a supplemental enhancement information (SEI) message including data for at least one of a Woodscape optical distortion model or a Brown-Conrady optical distortion model.

Clause 27. A device comprising a combination of the device of clause 25 and the device of clause 26.

Clause 28. A device for processing video data, the device comprising: means for encoding or decoding video data; and means for processing a supplemental enhancement information (SEI) message including camera extrinsics information representing a coordinate system and a format for indicating rotation data within the coordinate system for a camera used to capture the video data.

Clause 29. A device comprising a combination of the device of any of clauses 25-27 and the device of clause 28.

Clause 30. A method of processing video data, the method comprising: decoding video data of a bitstream to form decoded video data, the bitstream including the video data and a supplemental enhancement information (SEI) message including one or more camera parameters for a camera used to capture the video data; extracting the one or more camera parameters from the SEI message; determining physical capture characteristics of the camera used to capture the video data from the one or more camera parameters; and processing the decoded video data based on the physical capture characteristics to form processed video data.

Clause 31. The method of clause 30, wherein the physical capture characteristics comprise a scan interval of a rolling shutter of the camera.

Clause 32. The method of clause 31, wherein the SEI message comprises a shutter interval information SEI message including a rolling shutter information extension including the scan interval of the rolling shutter of the camera.

Clause 33. The method of any of clauses 31 and 32, wherein the one or more camera parameters comprise a syntax element specifying a rolling shutter scan order representing one of: top-to-bottom, bottom-to-top, left-to-right, or right-to-left.

Clause 34. The method of any of clauses 31-33, wherein the one or more camera parameters comprise syntax elements representing a scan interval and a scan delay for each of a plurality of temporal sublayers in a coded layer video sequence (CLVS) of the video data.

Clause 35. The method of any of clauses 30-34, wherein the physical capture characteristics comprise an optical distortion of a lens of the camera.

Clause 36. The method of clause 35, wherein the optical distortion represents a radial distortion model comprising at least one of an angle polynomial model or a Brown-Conrady model.

Clause 37. The method of clause 36, wherein the radial distortion model is the angle polynomial model, and the camera parameters indicate a number of coefficients of the angle polynomial model and a floating-point value for each of the coefficients of the angle polynomial model.

Clause 38. The method of clause 36, wherein the radial distortion model is the Brown-Conrady model, and the camera parameters include at least one tangential distortion parameter.

Clause 39. The method of clause 35, wherein the camera parameters include separate horizontal and vertical focal lengths and a horizontal and vertical focal center.

Clause 40. The method of any of clauses 30-39, wherein the physical capture characteristics comprise a spatial pose of the camera in a three-dimensional (3D) space, wherein the one or more camera parameters include a coordinate system indicator specifying one of a vehicle-centric coordinate system or a camera-centric coordinate system, and wherein the spatial pose comprises a camera orientation indicated by one of unit quaternions, a rotation matrix, or Euler angles.

Clause 41. The method of clause 40, wherein the orientation is indicated by unit quaternions, and the camera parameters include data representing a sign, an exponent, and a mantissa for each component of a quaternion.

Clause 42. The method of clause 40, wherein the orientation is indicated by the rotation matrix, and the camera parameters include data representing a sign, an exponent, and a mantissa for each component of a 3×3 rotation matrix.

Clause 43. The method of clause 40, wherein the camera parameters include a three-component translation vector representing a translation relative to an origin of a world coordinate system.

Clause 44. The method of any of clauses 30-43, further comprising providing the decoded video data and the physical capture characteristics to an advanced driver assistance system (ADAS).

Clause 45. A device for processing video data, the device comprising: a memory configured to store video data of a bitstream; and a processing system implemented in circuitry and configured to: decode the video data of the bitstream to form decoded video data, the bitstream including the video data and a supplemental enhancement information (SEI) message including one or more camera parameters for a camera used to capture the video data; extract the one or more camera parameters from the SEI message; determine physical capture characteristics of the camera used to capture the video data from the one or more camera parameters; and process the decoded video data based on the physical capture characteristics to form processed video data.

Clause 46. The device of clause 45, wherein the physical capture characteristics comprise a scan interval of a rolling shutter of the camera.

Clause 47. The device of clause 45, wherein the physical capture characteristics comprise an optical distortion of a lens of the camera.

Clause 48. The device of clause 45, further comprising a display configured to display the processed video data.

Clause 49. The device of clause 45, wherein the device comprises one or more of a computer, a mobile device, a broadcast receiver device, or a set-top box.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing video data, the method comprising:
decoding video data of a bitstream to form decoded video data, the bitstream including the video data and a supplemental enhancement information (SEI) message including one or more camera parameters for a camera used to capture the video data;
extracting the one or more camera parameters from the SEI message;
determining physical capture characteristics of the camera used to capture the video data from the one or more camera parameters; and
processing the decoded video data based on the physical capture characteristics to form processed video data.

2. The method of claim 1, wherein the physical capture characteristics comprise a scan interval of a rolling shutter of the camera.

3. The method of claim 2, wherein the SEI message comprises a shutter interval information SEI message including a rolling shutter information extension including the scan interval of the rolling shutter of the camera.

4. The method of claim 2, wherein the one or more camera parameters comprise a syntax element specifying a rolling shutter scan order representing one of: top-to-bottom, bottom-to-top, left-to-right, or right-to-left.

5. The method of claim 2, wherein the one or more camera parameters comprise syntax elements representing a scan interval and a scan delay for each of a plurality of temporal sublayers in a coded layer video sequence (CLVS) of the video data.

6. The method of claim 1, wherein the physical capture characteristics comprise an optical distortion of a lens of the camera.

7. The method of claim 6, wherein the optical distortion represents a radial distortion model comprising at least one of an angle polynomial model or a Brown-Conrady model.

8. The method of claim 7, wherein the radial distortion model is the angle polynomial model, and the one or more camera parameters indicate a number of coefficients of the angle polynomial model and a floating-point value for each of the coefficients of the angle polynomial model.

9. The method of claim 7, wherein the radial distortion model is the Brown-Conrady model, and the one or more camera parameters include at least one tangential distortion parameter.

10. The method of claim 6, wherein the one or more camera parameters include separate horizontal and vertical focal lengths and a horizontal and vertical focal center.

11. The method of claim 1, wherein the physical capture characteristics comprise a spatial pose of the camera in a three-dimensional (3D) space, wherein the one or more camera parameters include a coordinate system indicator specifying one of a vehicle-centric coordinate system or a camera-centric coordinate system, and wherein the spatial pose comprises a camera orientation indicated by one of unit quaternions, a rotation matrix, or Euler angles.

12. The method of claim 11, wherein the camera orientation is indicated by unit quaternions, and the one or more camera parameters include data representing a sign, an exponent, and a mantissa for at least three components of a quaternion.

13. The method of claim 11, wherein the camera orientation is indicated by the rotation matrix, and the one or more camera parameters include data representing a sign, an exponent, and a mantissa for each component of a 3×3 rotation matrix.

14. The method of claim 11, wherein the one or more camera parameters include a three-component translation vector representing a translation relative to an origin of a world coordinate system.

15. The method of claim 1, further comprising providing the decoded video data and the physical capture characteristics to an advanced driver assistance system (ADAS).

16. A device for processing video data, the device comprising:
a memory configured to store video data of a bitstream; and
a processing system implemented in circuitry and configured to:
decode the video data of the bitstream to form decoded video data, the bitstream including the video data and a supplemental enhancement information (SEI) message including one or more camera parameters for a camera used to capture the video data;
extract the one or more camera parameters from the SEI message;
determine physical capture characteristics of the camera used to capture the video data from the one or more camera parameters; and
process the decoded video data based on the physical capture characteristics to form processed video data.

17. The device of claim 16, wherein the physical capture characteristics comprise a scan interval of a rolling shutter of the camera.

18. The device of claim 16, wherein the physical capture characteristics comprise an optical distortion of a lens of the camera.

19. The device of claim 16, further comprising a display configured to display the processed video data.

20. The device of claim 16, wherein the device comprises one or more of a computer, a mobile device, a broadcast receiver device, or a set-top box.
